(19) United States
(12) Patent Application Publication
(10) Pub. No.: US 2017/0334522 A1
(43) Pub. Date: Nov. 23, 2017

(54) NETWORK-ENABLED BICYCLES, BICYCLES INTERCONNECTED INTO A MESH NETWORK, ELECTRONIC DEVICES FOR BICYCLES AND RELATED METHODS

(71) Applicant: VANHAWKS INC., Toronto (CA)

(72) Inventors: Sohaib Zahid, Toronto (CA); Niv Yahel, Toronto (CA); Eric Monteiro, Toronto (CA); Daanish Maan, Toronto (CA)

(21) Appl. No.: 15/527,770

(22) PCT Filed: Oct. 22, 2015
(86) PCT No.: PCT/IB2015/058170

§ 371 Date: May 18, 2017

Related U.S. Application Data
(60) Provisional application No. 62/081,283, filed on Nov. 18, 2014.
(60) Provisional application No. 62/088,745, filed on Dec. 8, 2014.

(51) Int. Cl. B62M 25/08; H04W 4/04; B62H 5/20; B62J 99/00; G08C 17/02; H04W 88/08; B62M 25/00

(52) U.S. Cl. CPC B62M 25/08; B62J 99/00; H04W 4/046; G08C 17/02; B62H 5/20; B62J 2099/0013; B62J 2099/002; B62M 2025/003; H04W 88/08; B62J 2099/004

(57) ABSTRACT

A network-enabled bicycle comprising a bicycle frame and an electronic device mounted to said bicycle frame is provide. The electronic device of network-enabled bicycle is configured to communicating with other network-enabled bicycles and/or a server via a wireless network access point. In general, a set of network-enabled bicycles are equipped with respective electronic devices which are programmed for allowing the bicycles in the set of bicycles to exchange data directly or indirectly with each other and/or exchange data directly or indirectly with the server via one or more of the wireless network access points connected to the server through a data network. In accordance with one specific example of implementation, the network-enabled bicycle connects to the wireless network access point over an open Wi-Fi connection.

### CROSS-REFERENCE TO RELATED APPLICATIONS

This application claims priority from U.S. Provisional Application No. 62/081,283, filed Nov. 18, 2014 and from U.S. Provisional Application No. 62/088,745, filed Dec. 8, 2014, the contents of each of which are incorporated herein by reference.

### FIELD OF THE INVENTION

The invention generally relates to network-enabled bicycles, bicycles configured for interconnecting with one another to form a mesh network, electronic devices for bicycles and related methods.

### BACKGROUND

Cyclists often desire access to a range of information while they are riding, prior to their ride or afterwards. Such information may include speed, position, elevation, inclination, traffic updates, route suggestions, road surface conditions, cycling lanes, information relating to a planned route, previous routes taken and related information to the previous routes taken, and various other information that may be relevant to a cyclist's riding experience.

Existing solutions for providing a cyclist with a range of cycling related information can be costly and/or typically require the cyclist to attach various sensors to his or her bicycle frame and/or to various components of the bicycle, such that these various sensors can communicates with an external electronic device, such as for example a smart phone. The process of attaching sensors can be tedious and time consuming. In addition, the external electronic device may need to be physically connected and disconnected from the sensors when the bicycle is unattended to prevent theft of the external electronic device.

Another issue of concern for users of bicycles pertains to bike theft. Existing anti-theft devices for bicycles have generally been limited to physically locking a bicycles frame and/or its components to bike racks, fences, street signs, parking meters, trees and other objects, and do not allow for a cyclist to easily view or track the current location of his or her bicycle.

Yet another issue of concern for users of bicycles pertains to shifting gears and particularly to automated and partially automated gear shifting. While there are some solutions for automatically shifting the gears of a bicycle, such solution tend to be generally limited to considering a cyclist's cadence (i.e., pedaling rate).

In light of the above, there is a need in the industry to provide devices and systems for use with bicycles that alleviate at least some of the deficiencies with existing solutions.

### SUMMARY

In accordance with a first aspect, a network-enabled bicycle is provided. The network-enabled bicycle comprises a bicycle frame and an electronic device mounted to said bicycle frame, said electronic device having a communication module, a non-transitory computer readable storage medium and a processor. The processor being programmed for monitoring operational parameters associated with the network-enabled bicycle and recording on the non-transitory computer readable storage medium data conveying information related to usage of the network-enabled bicycle. The processor further being programmed for using the communication module to detect a presence of an other network-enabled bicycle in a communication range of the network-enabled bicycle. The processor further being programmed for when the presence of the other network-enabled bicycle in the communication range of the network-enabled bicycle has been detected, using the communication module to establish a communication link with the other network-enabled bicycle and performing an exchange of data with the other network-enabled bicycle over the communication link, where during the exchange of data operational parameters associated with the other network-enabled bicycle are received and stored on the non-transitory computer readable storage medium.

In accordance with a first specific example of implementation of the network-enabled bicycle as provided in the first aspect, the processor is further programmed for using the communication module to detect a presence of a wireless network access point in a communication range of the network-enabled bicycle, wherein the wireless network access point facilitates a connection to a public data network. The processor is also further programmed for when the presence of the wireless network access point has been detected: (i) using the communication module to establish a communication link with the wireless network access point; and (ii) causing information stored on the non-transitory computer readable storage medium data to be transmitted to a remote computing device via the wireless network access point, wherein the remote computing device is in communication with the public data network, wherein the information transmitted to the remote computing device via the wireless network access point includes at least some information related to usage of the network-enabled bicycle and at least some information related to usage of the other network-enabled bicycle.

In accordance with a second specific example of implementation of the network-enabled bicycle as provided in the first specific example of implementation, the communication link established with the wireless network access point is established over an open Wi-Fi connection.

In accordance with a third specific example of implementation of the network-enabled bicycle as provided in the first aspect, the processor is further programmed for using the communication module to detect a presence of a portable communication device in a communication range of the network-enabled bicycle, the portable communication device being connectable with a wireless network access point, wherein the wireless network access point facilitates a connection to a public data network. The processor is further programmed for, when the presence of the portable communication device has been detected: (i) using the communication module to establish a communication link with the portable communication device; and (ii) causing information stored on the non-transitory computer readable storage medium data to be transmitted to a remote computing device via the portable communication device and the wireless network access point, wherein the remote computing device is in communication with the public data network, wherein the information transmitted to the remote computing device via the portable communication device and the wireless network access point includes at least some information related to usage of the network-enabled bicycle and at least some information related to usage of the other network-enabled bicycle.

In accordance with a second aspect, an electronic device for providing information of a plurality of network-enabled bicycles to a server is provided. The electronic device being a first electronic device associated with a first network-enabled bicycle of the plurality of network-enabled bicycles and having a first identifier associated with the first network-enabled bicycle. The first electronic device including control circuitry operative for recording a first set of data corresponding to use of the first network-enabled bicycle. The first electronic device further including control circuitry operative for connecting to a second electronic device, wherein the second electronic device is associated with a second network-enabled bicycle of the plurality of network-enabled bicycles. The first electronic device further including control circuitry operative for obtaining from the second electronic device a second identifier associated with the second network-enabled bicycle and a second set of data corresponding to use of the second network-enabled bicycle. The first electronic device further including control circuitry operative for connecting to a wireless network access point over an open Wi-Fi connection, wherein the wireless network access point facilitates a connection to the server and transmitting to the server via the open Wi-Fi connection the first set of data, the second set of data. The first electronic device further including control circuitry operative for an indication that the first set of data is associated with the first identifier and the second set of data is associated with the second identifier.

In accordance with a third aspect, a network-enabled bicycle is provided. The network-enabled bicycle comprising a bicycle frame and an electronic device as provided in the second aspect, wherein the electronic device is mounted to said bicycle frame.

In specific practical implementations the electronic device mounted to the bicycle frame is at least partially embedded within the bicycle frame.

In accordance with a fourth aspect, a method for connecting a first network-enabled bicycle to a network is provided. The network including a plurality of network-enabled bicycles, the plurality of network-enabled bicycles including at least a second network-enabled bicycle, said first network-enabled bicycle including having an electronic device and being associated with a first identifier. The method includes monitoring operational parameters associated with the first network-enabled bicycle and recording on a non-transitory computer readable storage medium of the electronic device data conveying information related to usage of the first network-enabled bicycle. The method further includes detecting a presence of the second network-enabled bicycle in a communication range of the first network-enabled bicycle. The method further includes when the presence of the second network-enabled bicycle in the communication range of the network-enabled bicycle has been detected, establishing a communication link between the first network-enabled bicycle and the second network-enabled bicycle and performing an exchange of data over the communication link, wherein during the exchange of data operational parameters associated with the second network-enabled bicycle are received and stored on the non-transitory computer readable storage medium of the electronic device. The method further includes detect a presence of a wireless network access point in a communication range of the first network-enabled bicycle, wherein the wireless network access point facilitates a connection a public data network. The method further includes when the presence of the wireless network access point has been detected, establishing a communication link between the first network-enabled bicycle and the wireless network access point, and causing information stored on the non-transitory computer readable storage medium data of the electronic device to be transmitted to a remote computing device via the wireless network access point, wherein the remote computing device is in communication with the public data network and wherein the information transmitted to the remote computing device via the wireless network access point includes at least some information related to usage of the first network-enabled bicycle and at least some information related to usage of the second network-enabled bicycle.

In accordance with a fifth aspect, a computer program product is provided. The computer program product is tangibly stored on one or more tangible computer readable storage media, for providing an owner of a first network-enabled bicycle with theft recovery functionality in connection with the first network-enabled bicycle, the first network-enabled bicycle being one of a plurality of network-enabled bicycles, the program product comprising instructions that, when executed, cause a programmable system including at least one programmable processor to perform operations. The operations including receiving information conveying a theft report in connection with the first network-enabled bicycle. The operations further including receiving data corresponding to position information of one or more of the plurality of network-enabled bicycles. The operations further including processing the received position information to determine if recent position information corresponding to the first network-enabled bicycle has been receiving, the recent position information being associated to a time period subsequent to receipt of the information conveying the theft of the first network-enabled bicycle. The operations further including when it is determined that specific recent position information corresponding to the first network-enabled bicycle has been received, generating an electronic notification message conveying the specific recent position information corresponding to the first network-enabled bicycle, and transmitting the electronic notification message over a data network to a computer device associated with the owner of the first network-enabled bicycle to notify the owner of the specific recent position information corresponding to the first network-enabled bicycle.

In accordance with a first specific example of implementation of the computer program product as provided in the fifth aspect, where receiving data corresponding to position information of one or more of the plurality of network-enabled bicycles is provided via the first network-enabled bicycle over an open Wi-Fi connection.

In accordance with a sixth aspect, a computer program product is provided. The computer program product is tangibly stored on one or more tangible computer readable storage media, for notifying an owner of a network-enabled bicycle of a possible theft of the network-enabled bicycle, the program product comprising instructions that, when executed, cause a programmable system including at least one programmable processor to perform operations. The operations comprising: (a) receiving a request over a data network to monitor the network-enabled bicycle; (b) establishing a connection with the network-enabled bicycle over an open Wi-Fi connection; (c) receiving a notification indicating a possible theft of the network-enabled bicycle; and (d) notifying the owner of the network-enabled bicycle of the possible theft.

In accordance with a seventh aspect, a network enabled bicycle is provided. The network-enabled bicycle is configured for establishing communication with other network-enabled bicycles over a mesh-network and for establishing communication with a remote server over a public data network via an open Wi-Fi connection, the network-enabled bicycle being configured for transmitting metrics related to usage of the network-enabled bicycle to the other network-enabled bicycles over the mesh-network.

In accordance with yet another aspect, a device for controlling a gear ratio of a bicycle is provided. The device comprises: a. an electronic device comprising control circuitry configured for: i. receiving inertia data from one or more sensors positioned on the bicycle; ii. processing the inertia data to determine an increment or a decrement of a gear ratio for the bicycle and the amount of the increment or the decrement of the gear ratio for the bicycle; iii. generating a control signal indicating the increment or the decrement of a gear ratio for the bicycle and the amount of the of the increment or the decrement of the gear ratio for the bicycle; iv. releasing the control signal; b. an actuator in communication with said electronic device for receiving said control signal, said actuator being configured for adjusting the gear ratio of the bicycle at least in part based on results obtained by processing said control signal.

In accordance with yet another aspect, a device for controlling a gear ratio of a bicycle is provided. The device comprises: a. an electronic device comprising control circuitry configured for: i. obtaining inertia data from one or more sensors positioned on the bicycle; ii. obtaining riding pattern data from a remote computer server over a data network; iii. processing the inertia data and the riding pattern data to determine an increment or a decrement of a gear ratio for the bicycle and the amount of the increment or the decrement of the gear ratio for the bicycle; iv. generating a control signal indicating the increment or the decrement of a gear ratio for the bicycle and the amount of the increment or the decrement of the gear ratio for the bicycle v. releasing the control signal; b. an actuator in communication with said electronic device for receiving said control signal, said actuator being configured for adjusting the gear ratio of the bicycle at least in part based on results obtained by processing said control signal.

In accordance with yet another aspect, a device for controlling a gear ratio of a bicycle is provided. The device comprises: a. an electronic device comprising control circuitry configured for: i. obtaining inertia data from one or more sensors positioned on the bicycle; ii. transmitting the inertia data over a data network to a computer server; iii. receiving from the computer server a shift command indicating an increment or a decrement of a gear ratio for the bicycle and the amount of the increment or the decrement of the gear ratio for the bicycle; iv. generating a control signal indicating the increment or the decrement of a gear ratio for the bicycle and the amount of the of the increment or the decrement of the gear ratio for the bicycle; v. releasing the control signal; b. an actuator in communication with said electronic device for receiving said control signal, said actuator being configured for adjusting the gear ratio of the bicycle at least in part based on results obtained by processing said control signal.

In accordance with yet another aspect, a method for conditioning a user interface to provide a user with an option to select a shifting preference of a bicycle, and adjusting a shifting sensitivity of the bicycle. The method comprises: a. implementing a graphic user interface (GUI) on a mobile computing device, the GUI configured to provide the user with a shifting preference of the bicycle, the shifting preference including an adaptive mode and a custom mode; b. in response to the selection of the adaptive mode, adjusting the shifting sensitivity of the bicycle automatically; c. in response to the selection of the custom mode, adjusting the shifting sensitivity of the bicycle based manually.

In accordance with yet another aspect, a method for controlling gear shifting preferences of a bicycle. The method comprises: a. generating data for causing a graphic display to be generated on a mobile computing device associated with the bicycle, the graphic display providing a user of the bicycle with input options for specifying gear shifting preferences, the input options allowing the user of the bicycle to select through a user input module a specific gear shifting preference from a group including at least: i. a first gear shifting preference associated with an adaptive mode for gear shifting; ii. a second gear shifting preference associated with a custom mode for gear shifting; b. receiving from the mobile computing device associated with associated with the bicycle data specifying the specific gear shifting preference selected by the user through the graphic display; c. processing the data specifying the specific gear shifting preference to control the shifting sensitivity of the bicycle wherein: i. when the specific gear shifting preference corresponds to the adaptive mode for gear shifting, adjusting the shifting sensitivity of the bicycle automatically; ii. when the specific gear shifting preference corresponds to the custom mode for gear shifting, adjusting the shifting sensitivity of the bicycle manually.

In accordance with yet another aspect, a device for controlling a gear ratio of a bicycle is provided. The device comprises: a. an electronic device comprising control circuitry operative for: i. receiving from a server a signal conveying that the bicycle has been reported as being stolen; ii. processing said received signal to generate a control signal for causing the gear ratio of the bicycle should be adjusted to a lowest gear; iii. releasing the control signal; b. an actuator in communication with said electronic device for receiving said control signal, said actuator being configured for adjusting the gear ratio of the bicycle to the lowest gear at least in part based on results obtained by processing said control signal.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 shows a set of network-enabled bicycles interconnected to one another in a network in accordance with a specific non-limiting example of implementation.

FIG. 2A shows one of the bicycles shown in FIG. 1 equipped with an electronic device in accordance with a specific implementation.

FIG. 2B shows a handlebar equipped with an electronic device in accordance with a specific non-limiting implementation.

FIG. 3 shows a block diagram of the electronic device shown in FIG. 2A in accordance with a specific implementation.

FIG. 4 shows a block diagram of a server to which bicycles in the set of bicycles may connect, directly or indirectly, as shown in FIG. 1 in accordance with a specific implementation.

FIG. 5 shows a block diagram of a wireless network access point to which bicycles in the set of bicycles may connect as shown in FIG. 1 in accordance with a specific implementation.

FIGS. 6A, 6B, 6C and 6D illustrate examples of records of position information which may be stored in computer readable memory of electronic devices of the type shown in FIG. 3 in accordance with a specific implementation.

FIGS. 7A and 7B illustrate examples of records of position information which may be stored in computer readable memory of electronic devices of the type shown in FIG. 3 in accordance with an alternative specific implementation.

FIG. 8 is a flowchart showing a process implemented by an electronic device of the type shown in FIG. 3 mounted to a bicycle for allowing the bicycle to connect and exchange information with other bicycles in the network shown in FIG. 1 in accordance with a specific implementation.

FIG. 9 is a flowchart showing a process implemented by an electronic device of the type shown in FIG. 3 mounted to a bicycle for allowing the bicycle to connect to a wireless network access point in accordance with a specific implementation.

FIGS. 10A and 10B illustrate examples of records of position information which may be stored in computer readable memory of the server shown in FIG. 4 in accordance with a specific implementation.

FIG. 11A shows a set of network-enabled bicycles where portable communication devices may be used to connect to a cellular network access point in accordance with a second non-limiting specific implementation.

FIG. 11B is a flowchart of a process for connecting a network-enabled bicycle to the cellular network access point shown in FIG. 11A in accordance with a specific implementation.

FIG. 12 is a flowchart for a process which may be implemented by a server on a network of the type depicted in FIG. 1 or in FIG. 11A in connection with theft of a bicycle in the set of bicycles.

FIG. 13 illustrate an example of a record that lists identifiers of stolen bicycles which may be stored in a database stored on a non-transitory computer readable storage medium in communication with a network of the type depicted in FIG. 1 or in FIG. 11A in accordance with a specific implementation.

FIGS. 14A, 14B and 14C illustrate examples of records conveying positioning information associated with at least one stolen bicycle in accordance with a specific implementation.

FIG. 15 illustrate an example of a record of positioning information which includes 9-axis inertial data in accordance with a specific implementation.

FIG. 16 is a flowchart for a process through which potholes on a circuit may be detected in accordance with a specific implementation.

FIG. 17 is a flowchart for a process through which congestion may be detected in accordance with a specific implementation.

FIG. 18 illustrates a flowchart of a process for registering a bicycle in association with a user's account in accordance with a specific implementation.

FIG. 19 illustrates a flowchart of a process for providing positioning information when requested by a user associated with a bicycle in accordance with a specific implementation.

FIG. 20 illustrates a flowchart of a first process for notifying an owner of a bicycle of motion or vibration of the owner's bicycle in accordance with a specific implementation.

FIG. 21 illustrates a flowchart of a second process for notifying an owner of a bicycle of motion or vibration of the owner's bicycle in accordance with a specific implementation FIG. 22 shows a block diagram of an electronic device of the type shown in FIG. 2A, an actuator and a shifting mechanism in accordance with a specific implementation.

FIG. 23 shows a rear wheel, drivetrain and a part of a frame of a bicycle of the type shown in FIG. 2A equipped with an electronic device in accordance with a specific implementation.

FIG. 24 shows a hub of the type shown in FIG. 23 in accordance with a specific implementation.

FIG. 25 illustrates a flowchart of a process for adjusting a gear ratio of a bicycle in accordance with a specific implementation.

FIG. 26 illustrates a flowchart of a first process for generating a control signal to adjust a gear ratio of a bicycle in accordance with a specific implementation.

FIG. 27A illustrates an example screenshot of a user interface of a mobile device for which a user may login to a server in accordance with a specific implementation.

FIG. 27B illustrates an example screenshot of a user interface of a mobile device for which a user may provide shifting preferences in accordance with a specific implementation.

FIG. 28A illustrates a flowchart of a second process for generating a control signal to adjust a gear ratio of a bicycle in accordance with a specific implementation.

FIG. 28B illustrates a flowchart of a third process for generating a control signal to adjust a gear ratio of a bicycle in accordance with a specific implementation.

FIG. 29 shows a block diagram of an electronic device of the type shown in FIG. 2A, an actuator, a shifting mechanism a mobile device and a server in accordance with a specific implementation.

FIG. 30 illustrates an example of a single grip on the right side of a bicycle handle bar in accordance with a specific implementation.

FIG. 31 illustrates an example of an electronic device and an actuator for compartmentalization in a bicycle hub.

It is to be expressly understood that the description and drawings are only for the purpose of illustrating certain embodiments of the invention and are an aid for understanding. They are not intended to be a definition of the limits of the invention.

### DETAILED DESCRIPTION

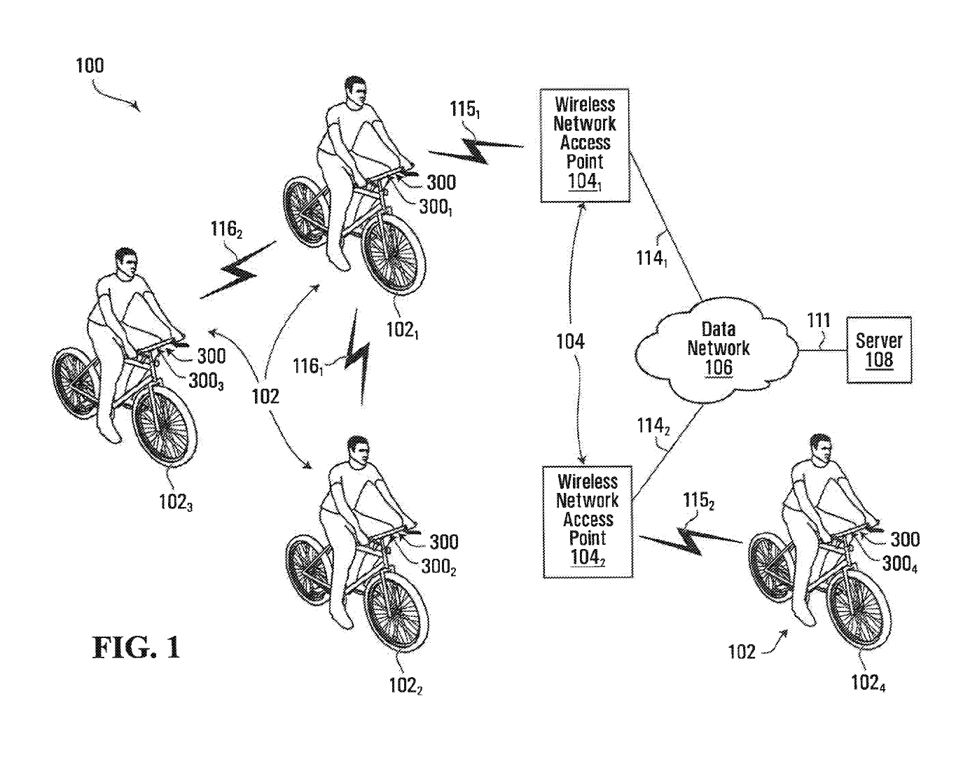

FIG. 1 shows a set of network-enabled bicycles 102 interconnected to one another in an electronic network 100 in accordance with a specific non-limiting example of implementation. As shown, the plurality of network-enabled bicycles 102 may be connected directly or indirectly to one another over a wireless link and/or connected directly or indirectly to one of a plurality of wireless network access points 104 to form a network of interconnection bicycles. The wireless network access points 104 are in turn in communication with a server 108 over a data network 106. In general, the set of bicycles 102 are equipped with respective electronic devices 300 programmed for allowing the bicycles in the set of bicycles to exchange data with each other and/or exchange data with the server 108 via one or more of the wireless network access points 104 connected to the server 108 through the data network 106.

Although in this example four bicycles 102₁ 102₂ 102₃ 102₄ and two wireless network access points 104₁ 104₂ are shown, in alternative implementations the number of bicycles 102 may be more or less than four and the number of wireless network access points 104 may be more or less than two. Similarly, although only a single data network 106 and a single server 108 are illustrated, in alternative implementations the data network 106 may comprise more than one data network and the server 108 may comprise multiple servers in some practical implementation.

In a typical practical implementation, each bicycle 102 is equipped with a respective electronic device 300 having the hardware components configured for collecting metrics related to the usage of the bicycle 102, which may include amongst other position information associated with the bicycle 102. Each electronic device 300 also includes hardware components configured for allowing it to establish communication links with each one of the other electronic devices 300 and(or) with each of the wireless network access points 104 that in proximity (within range) of it.

For example, when electronic device 300₃ (associated with bicycle 102₃) is in range of electronic device 300₁ (associated with bicycle 102₁), the electronic device 300₃ may detect electronic device 300₁ and establish a connection with it using any suitable communication protocol so that an exchange of data may be performed between the two bicycles 102₁ and 102₃. In a specific implementation, the exchange of data between the two bicycles 102₁ and 102₃ may include for example metrics related to the usage of the respective bicycles 102₁ and 102₃. As a result of such an exchange of data, each one of electronic devices 300₁ 300₃ may store information conveying metrics of both bicycles 102₁ and 102₃.

As indicated above, each of the electronic devices 300 includes hardware components that may also be configured for allowing it to establish communication links with each of the wireless network access points 104 that is in proximity (within range) of it. For example, when electronic device 300₁ (associated with bicycle 102₁) is in range of wireless network access point 104₁, the electronic device 300₁ may detect and establish a connection with wireless network access point 104₁ using any suitable communication protocol so that an exchange of data may be performed between the electronic device 300₁ and the server 108 (also referred to as a remote computing device) over network 106 via wireless network access point 104₁. More specifically, the wireless network access point 104₁ includes the required functionality for causing information provided by the wireless network access point 104₁ to be routed over the data network 106 so that it reaches one or more specific network destinations, which in this specific example includes the server 108. In a specific implementation, the exchange of data between the bicycle 102₁ and the server 108 may include for example metrics related to the usage of the bicycle 102₁, and optionally metrics related to the usage of any of the other bicycles 102₂ 102₃ depending on the information stored on electronic device 300₁, being transmitted from electronic device 300₁ to the server 108 via wireless network access point 104₁. The exchange of data between the bicycle 102₁ and server 108 may also include various data elements conveying contextual information that may be useful to either bicycles 102₁ or to bicycles that may be in the general vicinity of bicycles 102₁ being transmitted from the server 108 to electronic devices 300₁. For example, such contextual information may include, without being limited to, road condition information, traffic pattern information, incline information, advertizing information or any other suitable type of information. As a result of such an exchange of data, electronic device 300₁ may store information conveying contextual information provided from the server 108 and the server 108 may store metrics related to the usage of the bicycle 102₁, and optionally metrics related to the usage of any of the other bicycles 102₂ 102₃.

The network-enabled bicycles 102 interconnected to one another in an electronic network 100 of the type depicted in FIG. 1 may allow for a first bicycle 102₁ to send messages directly to the server 108 via a first wireless network access point and to send messages directly to a second bicycle 102₂. The network configuration shown in FIG. 1 may also allow the second bicycle 102₂ and third bicycle 102₃ to send message indirectly to the server 108 via the first bicycle 102₁. By way of another example, such a configuration may allow for the first bicycle 102₁ to directly send messages to the second bicycle 102₂ and the third bicycle 102₃, such that, the second bicycle 102₂ and the third bicycle 102₃ are able to send message indirectly to each other via first bicycle 102₁.

Yet in another example, a fourth bicycle 102₄ may directly communicate with the server 108 via a second wireless network access point 104₂ and the first bicycle 102₁ may directly communicate with the server 108 via the first wireless network access point 104₁, which may allow the fourth bicycle 102₄ and first bicycle 102₁ to indirectly communicate with each other. As such, the wireless network access points 104 may extend a network of interconnected bicycles 102₁ 102₂ 102₃ connected directly or indirectly to a first wireless network access point 104₁ to a network of interconnected bicycles 102₄ connected to a second wireless network access point 104₂. It is appreciated that such a configuration may allow for indirectly connected bicycles to exchange data with each other and with the server 108 without there being a direct connection between each bicycle and the server 108. Moreover, it is possible for a bicycle to communicate information to the server 108 while the bicycle has not itself been connected to a network but merely had established a connection with another bicycle that it had come in the vicinity of while travelling. It is thus appreciated that such a configuration may allow for the bicycles 102 to communicate data amongst each other such that when one of the bicycles from the set of bicycles 102 enters in range of one of the wireless network access points 104, the previously communicated data is then communicated to the server 108. In other words, and as will be described in great detail later on in the present description, the configuration shown in FIG. 1 may allows a bicycle (for example, second bicycle 102₂) to provide information to server 108 even though the second bicycle 102₂ is not at any point connection to a public data network (for example network 106) by virtue of the second bicycle 102₂ communicating with first bicycle 102₁ and the second bicycle 102₂ later entering communication with network 106.

The specific network between second bicycle 102₂, first bicycle 102₁ and third bicycle 102₃ can be implemented in some specific embodiments as a mesh (or mesh-type) network.

The bicycles 102, the electronic devices 300, the wireless network access points 104, the data network 106 and the server 108 is described in further detail later in this document and the functionality of each of the aforementioned components will likely become more readily apparent to the reader later on.

### Bicycles 102

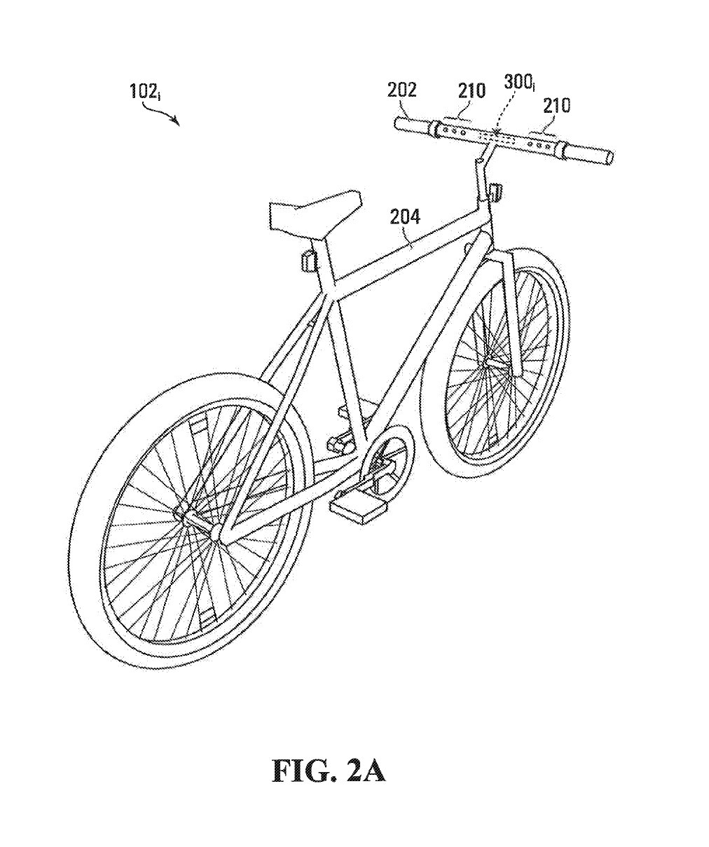

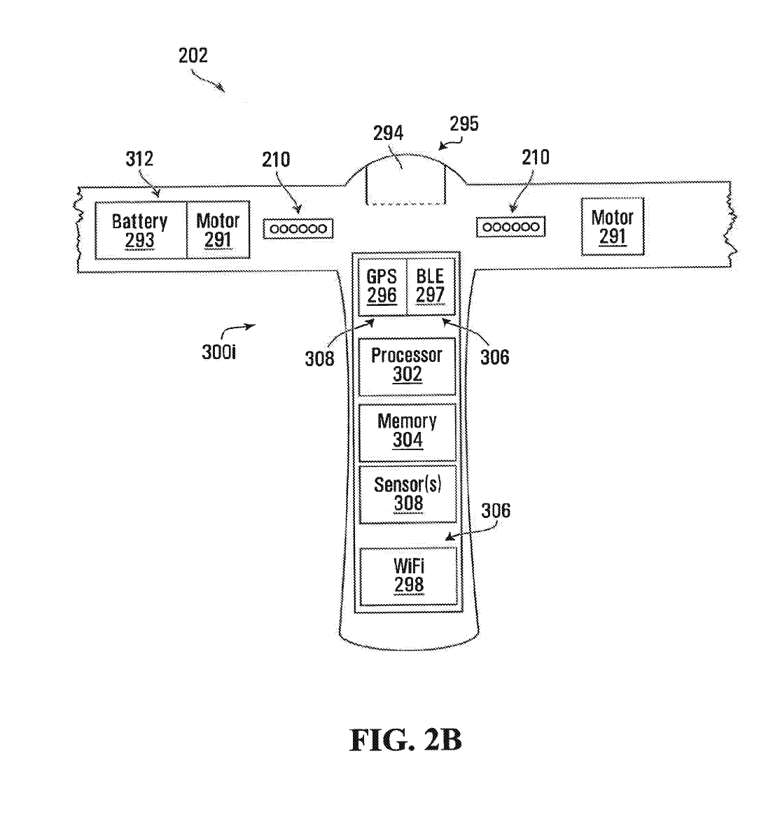

FIG. 2A shows one of the bicycles 102ᵢ from the set the bicycles 102 shown in FIG. 1 equipped with an electronic device 300ᵢ in accordance with a specific implementation. The bicycles 102 may be any type of bicycle (e.g., mountain bike, road bike, BMX bike, racing bike, touring bike, electric bike or any other suitable type of bicycle), and is not limited to the type of bicycle 102ᵢ illustrated in FIG. 2A. In this specific example, the electronic device 300ᵢ is compartmentalized within the bicycle 102ᵢ. In other words, in this example, the electronic device 300ᵢ is not external to the bicycle 102ᵢ but is at least partially embedded within the structure of the bicycle 102ᵢ. More specifically, as illustrated in this specific non-limiting example, the electronic device 300ᵢ is compartmentalized within the handle bars 202 of the bicycle 102ᵢ.

In other cases, the electronic device 300ᵢ may be compartmentalized or embedded within other parts of the frame 204 of the bicycle 102ᵢ, including but not limited to the head tube, fork, down tube, top tube, seat tube, chain stay, seat stay. In other case, the electronic device 300ᵢ may be compartmentalized or embedded within other parts of the bicycle 120ᵢ, including but not limited to the hub, shifter, brake leaver, pedal, seat, suspension, or any other suitable bicycle component.

It is appreciated that the compartmentalization of the electronic device 300ᵢ in the bicycle 120ᵢ may reduce the need of the cyclist to attach various sensors to his/her bicycle frame and/or to various components of the bicycle. It is also appreciated that the compartmentalization of the electronic device 300ᵢ in the bicycle 120ᵢ typically would not require the cyclist to disconnect the electronic device 300ᵢ from the bicycle 120ᵢ to prevent theft of the electronic device 300ᵢ. Still, it is also appreciated that the compartmentalization of the electronic device 300ᵢ in the bicycle 120ᵢ may render it more difficult for a thief to disconnect the electronic device 300ᵢ from the bicycle 120ᵢ, which may assist in rendering the theft prevention and tracking solution more effective.

The electronic device 300ᵢ may be compartmentalized within the bicycle 102ᵢ at the time of manufacturing of the bicycle 102ᵢ or may be compartmentalized within an existing bicycle not equipped with an electronic device. Preferable, the electronic device 300ᵢ within the bicycle 102ᵢ is embedded in a portion of the bicycle that cannot be easily tampered with, without dismantling parts of bicycle 102ᵢ. For example, but without being limited to, compartmentalizing the electronic device 300ᵢ within the handle bars 202 of the bicycle 102ᵢ. In other embodiments, the electronic device 300ᵢ may be compartmentalizing within the down-tube, steer-tube, gear hub, rear dropout, or any other suitable location of the frame of the bicycle 102ᵢ. It is appreciated that ease and reliability may be among the factors considered for determining the location to compartmentalize the electronic device 300ᵢ within the bicycle frame. For example, compartmentalizing the electronic device 300ᵢ within the down-tube may be less convenient than other possible locations, but may be more tamper-proof; the steer tube may be a suitable location to compartmentalize the electronic device 300ᵢ, as it is typically convenient to compartmentalize the electronic device 300ᵢ within the steer tube and may be relatively tamper-proof; the gear hub and rear dropout, may be relatively convenient locations within which to compartmentalize the electronic device 300ᵢ, but may possibly be more easily tampered with.

In some cases, the location of the electronic device 300ᵢ may be within the bicycle 102ᵢ or within a part of the bicycle 102ᵢ that can be replaced, such as for example, but without being limited to, the handle bars 202 and/or or the seat. It is appreciated that by compartmentalization of the electronic device 300ᵢ in a part of the bicycle 120ᵢ that can be replaced may allow for that part of the bicycle 120ᵢ to be replaced if the electronic device 300ᵢ breaks down, if that part of the bicycle 120ᵢ is stolen, or if the cyclist wishes to upgrade the electronic device 300ᵢ to a newer make or model.

As it will likely become more readily apparent later on, such a configuration of the electronic device 300ᵢ compartmentalized within the bicycle 102ᵢ may allow for the electronic device 300ᵢ to communicate, directly or indirectly, with the server 108 via one of the wireless network access points 104 and/or other electronic devices 300 of other bicycles 102 without the use of an external communication device.

In other embodiments, the electronic device 300ᵢ may not be compartmentalized or embedded within the bicycle 102ᵢ but rather may be embodiment as part of a device external to the bicycle and which can be fastened to the bicycle 102ᵢ using suitable fastening components. For example, the external device may be fastened to the bicycle 102ᵢ by a plastic and/or metal mounting mechanism which may be clipped or screwed onto a component of the frame or other part of the bicycle 102ᵢ. Many suitable types of mounting mechanisms for fastening devices to bicycles have be made and many are commercially available mounts, for example, by RAM MOUNTS™ (National Products, Inc) and other manufacturers/vendors. It is to be appreciated the type of mounting mechanism used is not critical to the functionality contemplated in the present description is thus will not be described in further detail here.

In yet other embodiments, the electronic device 300ᵢ may not be compartmentalized or embedded within the bicycle 102ᵢ but rather may be embodiment as part of a device external to the bicycle and which can be carried by the cyclist (e.g., in a pocket or in a bag that the cyclist is carrying).

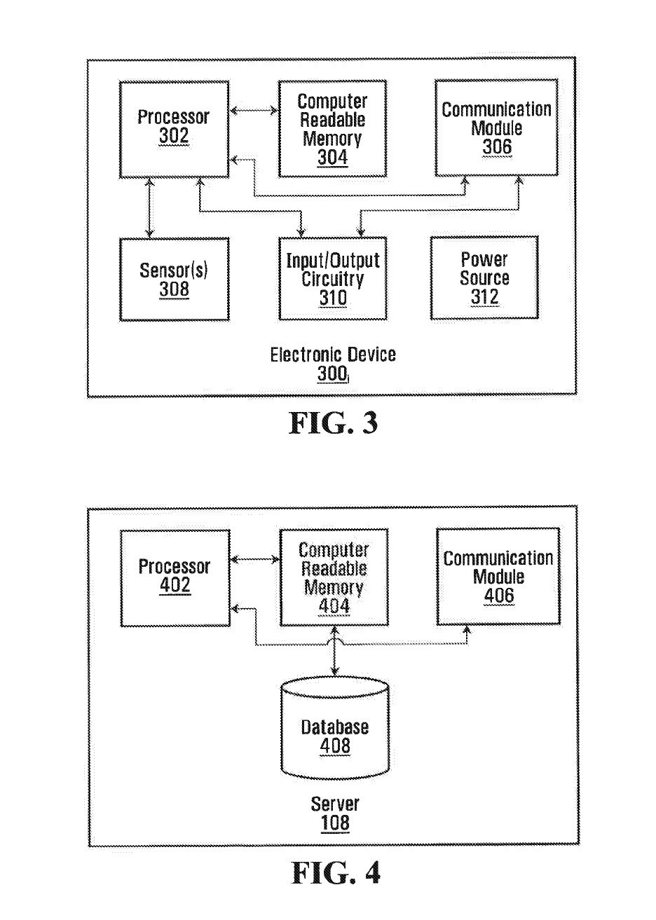

FIG. 3 shows a block diagram of the electronic device 300ᵢ shown in FIG. 2A in accordance with a specific implementation. As illustrated, the electronic device 300ᵢ includes a processor 302, a computer readable memory 304, a communication module 306, one or more sensors 308, and suitable input/output circuitry 310. The processor 302, the computer readable memory 304, the communication module 306, the one or more sensors 308, and the input/output circuitry 310 may communicate with each other via one or more suitable data communication buses.

The processor 302 may be implemented using any suitable hardware component for implementing a central processing unit (CPU) including a microcontroller, field-programmable gate array (FPGA), application-specific integrated circuit (ASIC), digital signal processor (DSP), an integrated circuit (IC) or any other suitable device. The processor 302 is in communication with the computer readable memory 304, such that the processor 302 is configured to read data obtain from the computer readable member 304 and execute instructions stored in the computer readable memory 304 and to control the various components of electronic device 300ᵢ. In some implementations, the processor 302 executes instructions stored in the computer readable memory 304 to derive information useful to the user of the bicycle 102ᵢ based at least in part on at the metrics obtained by the sensors 308, such as for example information regarding speed, inclination, distance, location, duration or any other suitable information that may be of interest to the user.

The computer readable memory 304 may be any type of non-volatile memory (e.g., flash memory, read-only memory (ROM), magnetic computer storage devices or any other suitable type of memory) or semi-permanent memory (e.g., random access memory (RAM) or any other suitable type of memory). Although only a single computer memory 304 is illustrated, the electronic device 300ᵢ may have more than one computer readable memory module. The computer readable memory 304 may store program code and/or instructions which may be executed by the processor 302. The computer readable memory 304 may also include one or more databases for the storage of data.

The communication module 306 includes an antenna suitable for transmitting data from the electronic device 300ᵢ and/or receiving data intended for the electronic device 300ᵢ. The communication module 306 may be operationally connected to the processor 302 for instructing it as to which data is to be transmitted and/or for forwarding to it received data for processing. The communication module 306 may include one or more modules for communicating with third party device using a Wi-Fi protocol (e.g., IEEE 802.11 protocol), Bluetooth protocol, cellular network protocol(s) (e.g., GSM, AMPS, GPRS, CDMA, EV-DO, EDGE 3GSM, DECT, IS-136/TDMA, iDen, LTE or any other suitable cellular protocol), ZigBee protocol (e.g., IEEE 802.15 protocol), protocols operating in the 900 MHz, 2.4 GHz, 5.6 GHz ranges, or any other suitable protocol or any combination thereof. Although only a single communication module 306 is illustrated in the electronic device 300, different communication modules may be used to implement different communication protocols. The communication module 306 may be used to communicate, directly or indirectly, with communication modules present in other bicycles, to communicate with Wi-Fi hotspot access points, to communicate with a cellular network, to communicate with a mobile device (e.g., cellular phone, tablet or any other suitable device) or to communicate with any other suitable third party device.

The electronic device 300ᵢ has an identifier for uniquely identifying the electronic devices 300ᵢ to the network 100. The identifier may be a media access control (MAC) address, IP address (e.g., IPv4 or IPv6 address) or any other suitable identifier allowing to uniquely identify the electronic device 300ᵢ. In some cases, the identifier is a network address assigned to the electronic device 300ᵢ. The assigned network address may be a static network address. This static network address may be assigned to the electronic devices 300ᵢ before the bicycle 102ᵢ is shipped and sold to the cyclist or distributor, during an initial registration process or at another suitable time. In another non-limiting embodiment, the electronic devices 300ᵢ may be assigned a dynamic network address. For example, in a non-limiting scenario, a Dynamic Host Configuration Protocol (DHCP) server (not depicted) may be used to assign the dynamic network address (such as, for example, a dynamic IP address) to the electronic devices 300ᵢ.

It is appreciated that the identifiers of the electronic devices 300 may be network addresses that may be used to specifically identify each of electronic devices 300 (e.g., nodes) in the network 100. By being able to specifically identify each of electronic devices 300 (e.g., nodes), it may be possible to route communications to specific electronic devices 300 (e.g., nodes) in the network. As the use of network addresses for routing communication between different nodes in a network is within the knowledge of the person of skill in the art, it will not be described in further detail here.

The sensors 308 may include one or more sensors for detecting any suitable metric related to the use of bicycle 102ᵢ, including for example speed, pace, acceleration, distance, time, incline, decline, altitude, torque, power generated, cadence, orientation, gear, location, latitude, longitude, elevation, yaw-pitch roll, angular velocity (in three dimensions), linear acceleration (in three dimensions), or any other suitable metric.

It is appreciated that the relative orientation of the cyclist relative to the ground they are riding on may be useful for applications concerned with pot-hole detection, crash detection and the like. In addition to event detection, such as pot-hole detection and crash detection, the orientation of the cyclist may be used in calculating the number of calories burned by the cyclist. It is also appreciated that torque may be usefully for calculating how much energy the cyclist is exerting. It is also appreciated that cadence may be useful for determining how frequently the cyclist is shifting gears.

Although the sensors 308 are illustrated as internal to the electronic device 300ᵢ, in other cases some of the one or more sensors 308 may be external to the electronic device 300ᵢ and may be connected to different parts of the bicycle 102ᵢ in order to collect various suitable measurements of the type mentioned above. In the cases where some of the one or more of the sensors 308 are external to the electronic device 300ᵢ, the sensors 308 may be connected to the electronic device 300ᵢ via the input/output circuitry 310. Any suitable type of sensors 308 can be used to determine one or more of these aforementioned metrics, including for example a 9-axis inertial monitoring unit, Hall effect sensor, a magnetic sensor, a strain gauge, a photo-electric sensor, an accelerometer, positioning circuitry (e.g., Global Positioning System (GPS) circuitry), a Barometer, a real-time clock (RTC), a motion sensor, a ultra-sonic detector, a gyroscope, a magnetometer, a speedometer, a temperature sensor, torque sensor, cog counter or any other suitable sensor. The sensors 308 provide suitable metrics related to the use of bicycle 102ᵢ depending on the sensors functionality and the suitable metrics related to the use of bicycle 102ᵢ may be provided in the form of data which can be stored in the computer readable memory 304 and/or processed by the processor 302. Suitable sensors for collecting metrics related to use of a bicycle or other vehicles have been used in the past and the specific manner in which such sensor collect metrics is not critical and goes beyond the scope of the present document and thus will not be described in further detail here.

The input/output circuitry 310 may be used to connect to one or more external sensors and may be used for receiving information conveying various metrics related to the use of bicycle 102ᵢ. The input/output circuitry 310 may also be used to release information to the user of the bicycle 102ᵢ to convey to the user information derived by the processor 302 based at least in part on the metrics obtained by the sensors 308 or other relevant data or information. In a non-limiting example, the input/output circuitry 310 may be connected to a plurality of display element, such a display screen, light element (LEDs for example) or other visual elements for conveying information to a user of the bicycle 102ᵢ. For example, as illustrated in FIG. 2A, input/output circuitry 310 may be connected to a set of visual indicators 210 positioned on the handlebars 202 of the bicycle 102ᵢ to provide turn-by-turn navigation. More specifically, the plurality of indicators 210 positioned on the handlebars 202, which may be implemented with light emitting diodes (LEDs) positioned on the right side and left of the handlebars 202. The signals released form the input/output circuitry 310 may be derived by the processor 302 at least in part by processing information obtained by the sensors 308, cause the LEDs positioned on the right side light up to indicate a right turn and the LEDs positioned on the left side of the handlebars light up to indicate a left turn. In other cases, input/output circuitry 310 may be used to connect to one or more external devices. For example, in some embodiments, an external turn-by-turn bicycle navigation system.

The electronic device 300ᵢ also includes a power source 312, which may be embodied as a battery (e.g., lithium battery, alkaline battery, metal hydride battery, nickel metal hydride battery or any other suitable battery), a power generator connected to a wheel or other part of the bicycle 102 that is able to provide power when the bicycle is in movement (e.g., a dynamo) or any other suitable power source. Batteries and bicycle dynamo generators are commercially available and are commonly known to the person skilled in the art and, as such, are not discussed in detail in this document. The electronic device 300ᵢ may have an outlet for recharging the power source 312 by connecting the outlet to an AC or DC power source (e.g., a 120 volt AC outlet or any other suitable outlet).

FIG. 2B shows a specific non-limiting example of the handlebar 202 of the bicycle illustrated in FIG. 2A. As illustrated, the electronic device 300ᵢ is compartmentalized within the handle bars 202. In this example, the power source 312 is in the form of a battery 292. Sensors 308 are also provided in this example and include a GPS module 296. Two communication modules 306 are provided including a Bluetooth low energy module (BLE) 297 and a Wi-Fi communication module 298. In this example, the Bluetooth module 297 and the GPS module 296 are provided in aperture formed in the stem of the handle bar, the aperture having a dimension of approximately 2 cm by 2 cm. It is to be appreciated however that the aperture in alternative embodiment may be of any other suitable size. The handlebar 202 may be manufactured of aluminum or any other suitable material and optionally injection molded plastic may be applied to fill and conceal the aperture. In this specific implementation, motors 291 are also provided in this example for the haptic feedback (e.g., vibration of the handlebar 202 of the bicycle 102ᵢ). The other electronic components, such as, the processor 302 and computer readable memory 304 are also compartmentalized within the handle bars 202. Optional, as shown in the illustrated example, an aperture 295 may be provided for a headlamp 294. Optionally still, as shown in the illustrated example, navigation lights 210 are provided.

### Server 108

As shown in FIG. 1, the plurality of network-enabled bicycles 102 may be connected directly or indirectly to one another over a wireless link and/or connected directly or indirectly to one of a plurality of wireless network access points 104 to form a network of interconnection bicycles. The wireless network access points 104 and the network-enabled bicycles 102 may in turn be connection directly or indirectly to a server 108 over a data network 106.

FIG. 4 shows a block diagram of the server 108 to which bicycles in the set of bicycles 102 may connect, directly or indirectly in accordance with a specific implementation. In this embodiment, the server 108 comprises a processor 402, a computer readable memory 404 and a communication module 406. Although only a single server 108 is illustrated in FIG. 4, it is appreciated that one or more servers may be used. In other words, the functionality of server 108 may be embodied by single computing device of by a plurality of physical computers which may be located in a common place or different places. In a non-limiting implementation, the server 108 is a cloud server and/or is part of a cloud computing platform. The processor 402 may be implemented by one or more central processing units (CPU) (e.g., provided by Intel, AMD or any other CPU manufacturer) or any other suitable device. The computer readable memory 404 may be any suitable type of non-volatile memory (e.g., flash memory, read-only memory (ROM), magnetic computer storage devices or any other suitable type of memory) and includes storage elements and/or modules for storing databases 408.

The computer readable memory 404 may also stored a set of executable instructions in the form of application software implementing various functionality/applications and which are executable by the processor 402. The application software may include an application that allows a user to create an account, allows the user to associate that account with one or more bicycles, allows a user to login to the account to view information, allows for the server to obtain and store information related to the use of bicycles, allows a user to view current and previous locations of the one or more bicycles associated with his/her account, allows a user to report a bicycle stolen, allows for the server to notify the user of a location of a stolen bicycle, and other operations a few of which will be discussed throughout this document.

The communication module 406 may be any suitable module for communicating with the data network 106 (e.g., Ethernet module, Wi-Fi module, optical communication module, or any other suitable device). Although not illustrated the connection of the communication module 406 to the data network 106 may include the use of an access device (e.g., a modem, such as cable modem, an xDSL modem, an Optical Network Terminal (ONT) or any other suitable device).

### Data Network 106

Referring back to FIG. 1, the data network 106 may be any suitable data network for facilitating the exchange on information between the server 108 and the wireless network access points 104. In a specific non-limiting embodiment, the data network 106 may in whole or in part be located on a public data network (the Internet) or may in whole or in part be located on a private data network. In alternative embodiments, the data network 106 may in whole or in part be located on the Public Switched Telephone Network (PSTN), a wireless data network or any other suitable type of data network.

In a non-limiting embodiment of the present invention, the access connection 111 between the server 108 and the data network 106 and the access connections 114₁ 114₂ between the data network 106 and the wireless network access points 104₁ 104₂ may be a copper twisted pair over which higher-layer protocols allow for the exchange of packets (e.g., an xDSL-based access link), an Ethernet link, a fiber optic link (e.g., Fiber-to-the-Premise, Fiber-to-the-Curb, etc.), a wireless link (e.g., EV-DO, WiMax, Wi-Fi, CDMA, TDMA, GSM, UMTS, and the like), coaxial cable link, or any other suitable link, or a combination thereof. Generally speaking, the access connections 111 114₁ 114₂ may comprise any type of wireless, wired or optical connection that allows exchange of data between the server 108, the data network 106 and the wireless network access points 104₁ 104₂.

### Wi-Fi Access Points 104

As shown in FIG. 1, the plurality of network-enabled bicycles 102 may be connected directly or indirectly to one another over a wireless link and/or connected directly or indirectly to one of a plurality of wireless network access points 104 to form a network of interconnected bicycles.

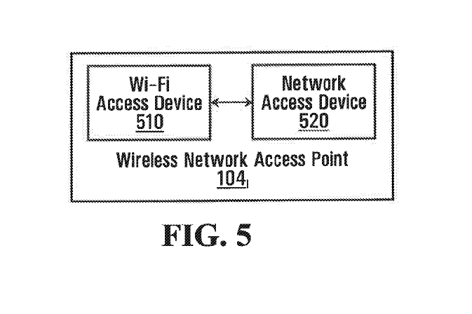

FIG. 5 shows a block diagram of wireless network access point 104ᵢ to which bicycles in the set of bicycles 102 may connect in accordance with a specific implementation. In this embodiment, the wireless network access point 104ᵢ is a Wi-Fi access point. In general, a Wi-Fi access point is a site that offers Internet access over a wireless local area network (WLAN) through the use of a router connected to a link to an Internet service provider. As illustrated, the access point 104ᵢ includes a Wi-Fi access device 510 and a network access device 520 connected to each other.

The network access device 520 may comprise a modem that is connected to a link (e.g., the link 114₁ or 114₂) to an Internet service provider. Examples of modems that can be used include, but are not limited to, a cable modem, an xDSL modem and the like. In alternative embodiments of the present invention, which are particularly applicable where the access connections (e.g., the links 114₁ or 114₂) comprise Fiber-to-the-premise, the network access device 520 may comprise an Optical Network Terminal (ONT). Naturally, the type of the network access device 520 depends on the type of the access connections (e.g., the links 114₁ or 114₂) employed.

In a specific embodiment, the Wi-Fi access device 510 includes a wireless router. Examples of wireless routers that can be used include, but are not limited to, routers that implement Wi-Fi/IEEE 802.11 protocol (e.g., 802.11a, 802.11g, 802.11n, 802.11ac or any other suitable protocol). Wireless routers of this type are commercially available and are within the knowledge of the person of skill in the art and, as such, are not discussed in detail in this document. The connection of the Wi-Fi access device 510 to the network access device 520 allows for access to the data network 106 (e.g., Internet access) to be provided to devices, such as but not limited to the electronic device 300ᵢ, that may connect to the Wi-Fi access device 510.

In some embodiments of the invention one or more of the wireless network access points 104 are open Wi-Fi access points or open Wi-Fi hotspots. Wi-Fi hotspots are often found at airports, bookstores, coffee shops, department stores, fuel stations, hotels, hospitals, libraries, public pay phones, restaurants, RV parks and campgrounds, supermarkets, train stations, schools, universities and other public places. In general, a Wi-Fi hotspot is “open” or “free” if the Wi-Fi access device 510 (e.g., the Wi-Fi router) provides an open public network in which device employing an accepted Wi-Fi standard is in range of the Wi-Fi access device 510 can connect to. The Wi-Fi access device 510 is configured for accepted connections requests made by any device with little, if any, restriction on the Wi-Fi enabled devices that may connect to it. For instance, in the case of the electronic device 300ᵢ connecting via the communication module 306 to the open Wi-FI access device 510, the electronic device 300ᵢ may gain access to the data network 106, without having to providing authentication or access information (e.g., a username and/or password) or undergo an analogous access control process.

In other cases the Wi-Fi hotspot is “open” or “free” but employs a closed public network and may use a hotspot management system to limit access to its network. In such cases, software may run on the Wi-Fi access device 510, or on an external computer, allowing operators of the wireless network access point 104ᵢ to authorize only specific users to access the data network 106. In other words, a restriction is placed on the Wi-Fi enabled devices that may connect and gain access to the public network.

By way of example, when the bicycle 102ᵢ of the set of bicycles 102 passes within range of the wireless network access point 104ᵢ (e.g., a Wi-Fi hotspot) it may detect and connect to the wireless network access point 104ᵢ to gain access to the server 108 and then the server 108 and the bicycle 102ᵢ may communicate with each other. When the open Wi-Fi hotspot provides an open public network, the bicycle 102ᵢ may gain access to the server 108 by physically entering the range of the Wi-Fi hotspot and then connecting to the Wi-Fi hotspot to then gain access to the public network using known methods. In such a case, the bicycle 102ᵢ may then upload to the server 108 bicycle use information of one or more of the bicycles 102 or any other suitable information. In other cases, where the open Wi-Fi hotspot provides a closed public network, additional steps may be required to be taken for the bicycle 102ᵢ to gain access to the public network 106 and hence to the server 108. In order to gain access to Wi-Fi hotspot that provide closes public networks, access information may be stored in the computer readable memory 304 of the electronic device 300ᵢ of the bicycle 102ᵢ. When such a Wi-Fi hotspot is detected, in order to gain access to the network 106, the bicycle 102ᵢ can provide the access information to the open Wi-Fi hotspot that provides a closed public network to gain access to the public network and then to the server 108.

More specifically, the additional steps that may be required by the bicycle 102ᵢ to gain access to Wi-Fi hotspots that provide a closed public network and/or use a hotspot management system to control access, may include the communication module 306 of the electronic device 300ᵢ first connecting to the Wi-Fi hotspot (e.g., Wi-Fi access device 510) and then secondly providing access information, such as, a user name and/or a password, passcodes, or providing some other indicator to indicate to the wireless network access point 104 that the electronic device 300ᵢ is authorized to gain access. Once the electronic device 300ᵢ gains access to closed public network, the electronic device 300ᵢ may then communicate to the server 108 via the data network 106.

It is appreciated that, in some cases, an agreement may be made with the manufacturer, distributors or users of the bicycles 102 to gain access to Wi-Fi hotspots that provide a closed public network and/or use a hotspot management system to control access to the hotspot. When such agreements are made the access information (such as passcodes) may be stored in the computer readable memory 304 of the electronic device 300ᵢ of the bicycle 102ᵢ prior to the bicycle 102ᵢ entering in the range of the Wi-Fi hotspots that provide a closed public network. This access information may be programmed into the computer readable memory 304 of the electronic device 300ᵢ by the server 108 or may be programmed into the computer readable memory 304 of the electronic device 300ᵢ prior to the cyclist purchasing the bicycle 102ᵢ. In other words, the computer readable memory 304 of the electronic device may include a record of available Wi-Fi hotspots that require authentication with a hotspot management system and the relevant access information (e.g., password, username, or other suitable indicators) to gain access. Alternatively, such information may be programmed using any other suitable mechanism including but not limited to any suitable mechanisms for updating and upgrading firmware in electronic devices.

### Examples of the Functionality of the Network Enabled Bicycles

Referring back to FIG. 1, specific and non-limiting examples of processes implemented in connection with the network-enabled bicycles 102₁ 102₂ 102₃ 102₄ will be described. For the purpose of these examples, each bicycle 102₁ 102₂ 102₃ 102₄ is considered to be a separate implementation of the bicycle 102ᵢ. Also, in these examples, each bicycle 102₁ 102₂ 102₃ 102₄ has a respective electronic device 300₁ 300₂ 300₃ 300₄, where each of the electronic devices 300₁ 300₂ 300₃ 300₄ is a separate implementation of the electronic device 300ᵢ.

Registration of Bicycles with a Server 108

After the purchase of the bicycle 102ᵢ and/or the electronic device 300ᵢ, the bicycle 102ᵢ and/or the electronic device 300ᵢ may have to be registered with the server 108 in order for the electronic device 300ᵢ to function within the network 100 and provide its user with network enhanced functionality. For example, the registration of the bicycle 102ᵢ and/or the electronic device 300ᵢ with the server 108 may take place as discussed below.

A user (for example, the owner of the bicycle 102ᵢ) may connect with a computing device (e.g., cell phone, tablet, computer, and the like) to the server 108 over the data network 106 (e.g., the Internet) via a web browser or any other suitable application (e.g., mobile phone application). The user may be prompted to create a new account, if the user does not have an existing account with the server 108. This account creation may include entering in a name, username, password, email address, contact information and/or any other suitable information.

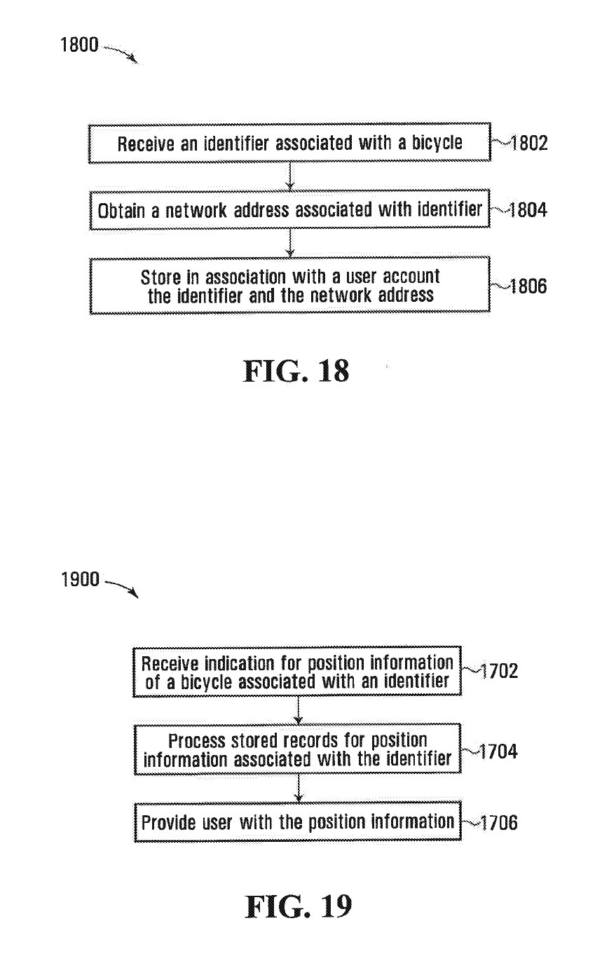

Once the account associated with the user is created or during the account creation process, the server 108 may request from the user that the user provide an identifier associated with the bicycle 102ᵢ and/or the electronic device 300ᵢ, so that the server 108 can associate the bicycle 102ᵢ and/or the electronic device 300ᵢ with the user's account. FIG. 18 illustrates a flowchart of a process 1800 which the server 108 may implement when registering a bicycle 102ᵢ in association with a user's account. At step 1802, the user may provide to the server 108 an identifier associated with the bicycle 102ᵢ and/or the electronic device 300ᵢ. For example, the identifier could be a serial number present on the bicycle 102ᵢ, a serial number present on the electronic device 103, or the part of the bicycle that has the electronic device embedded within (e.g., the handle bars), an identifying number provided with the purchase of the bicycle 102ᵢ, or any other suitable identifier provided to the user in any other suitable way. In some cases, the bicycle 102ᵢ may be provided with an identifier that is used for the manufacturing and shipping purposes and the electronic device 300ᵢ has a unique identifier which is used in the registration process. In this example, the provided identifier (e.g., the serial number) is a first identifier used by the server 108 to obtain from a record stored in the computer readable memory 404 a second identifier. More specifically, in this example, the second identifier is a network address, (e.g., media access control (MAC) address, IP address (e.g., IPv4 or IPv6 address) or any other suitable network address) associated with the provided first identifier (e.g., the serial number). At step 1804, the provided identifier (e.g., the serial number) is used to obtain a network address associated with the provided identifier (e.g., the serial number). This step may include looking up the network address associated with a provided identifier (e.g., serial number) in a record stored in the computer readable memory 404. For example, when the user provides a serial number associated with the bicycle 102ᵢ the server 108 may then use this serial number to obtain a MAC address associated with the serial number. Then at step 1806, the provided identifier and the network address associated with the identifier, which correspond to the bicycle 102ᵢ and/or the electronic device 300ᵢ, is stored in association with the user's account in the computer readable memory 404.

In some cases, the unique identifier of the electronic device 300ᵢ is associated with a unique user in the server 108. For example, when the bicycle 102ᵢ is purchased the unique identifier may be stored in the database 408 of the computer readable memory 404 of the server 108 in association with the purchaser's user information, such as, name, email, and any other suitable information. For instance, when the bicycle 102ᵢ is ordered online the user information of the user (e.g., the purchaser) may be obtained and prior to the bicycle being shipped to the user, the unique identifier of the electronic device 300ᵢ may be recorded in the database 408 is association with user information. In other words, when the user orders the bike the user may create an account with the server 108 and the server 108 may then be able to store the unique identifier of the electronic device 300ᵢ in association with the user.

By way of another example, after the user receives the bicycle 102ᵢ, the user may register with the server 108, for example by connecting to the server with a computing device (e.g., computer, cell phone, tablet or any other suitable device) and entering in the serial number provided with the bicycle 102ᵢ/electronic device 300ᵢ.

Yet in other cases, after the user receives the bicycle 102ᵢ the user may be required to connect the electronic device 300ᵢ to a portable computing device (e.g., computer, cell-phone, tablet or any other suitable device) which may take place over a Bluetooth connection or near-field communication (NFC) connection and an application running on the portable computing device may obtain the unique identifier of the electronic device 300ᵢ from the electronic device 300ᵢ. This application running on the portable computing device may then communicate with the server 108, such that the portable computing device provides the server 108 with the unique identifier of the electronic device 300ᵢ and the user information of the user. It is appreciated that in this case, that the user may not have to manually entering the unique identifier. Then the server 108 may record the unique identifier in association with the user's account.

It is also appreciated that, in these examples, the unique identifier may be the MAC address of the communication module 306. For example, the unique identifier may be the MAC of a Wi-Fi module or the MAC address of a Bluetooth module. In some cases, the unique identifier may be more than one unique identifier; for example, the MAC of a Wi-Fi module and the MAC address of a Bluetooth module.

Yet, in other cases, the provided identifier (e.g., the serial number) is only identifier stored in association with the bicycle 102ᵢ and/or the electronic device 300ᵢ in the user's account.

Regardless of the type of identifier used, it is appreciated that in these examples that each of the electronic devices 300₁ 300₂ 300₃ 300₄ of the respective bicycles 102₁ 102₂ 102₃ 102₄ has a unique identifier. The identifiers of the electronic devices 300₁ 300₂ 300₃ 300₄ may be factory set identifiers or may be identifiers that are received at the electronic devices 300₁ 300₂ 300₃ 300₄ when the electronic devices 300₁ 300₂ 300₃ 300₄ are registered with the server 108.

At the registration stage, the user/owner of the bicycle 102ᵢ may be required to connect the electronic device 300ᵢ to the server 108 via the communication module 306 of the electronic device 300ᵢ. This may include connecting the electronic device 300ᵢ to a wireless network access point 104ᵢ or to a portable computing device (e.g., a cellular phone over Bluetooth) which is connect to a cellular network. At this registration stage, the electronic device 300ᵢ may be provided with the unique identifier and/or may be updated with relevant information. For example, the electronic device 300ᵢ may be updated with a list of other the electronic devices 300 that it may communicate with. For example, the list of other electronic devices 300 that it may communicate with may be a list of identifiers of the other electronic devices 300 (e.g., list of MAC addresses, list of IP addresses, or list of other suitable identifiers). At this stage, the electronic device 300ᵢ may be updated with a list of records of available Wi-Fi hotspots that require authentication with a hotspot management system and the relevant data (e.g., password, username, or other suitable indicators) to gain access.

For illustration purposes, in these specific and non-limiting examples, the electronic devices 300₁ has the identifier “00001”, the electronic devices 300₂ has the identifier “00002”, the electronic devices 300₃ has the identifier “00003”, and the electronic devices 300₄ has the identifier “00004”. In other words, each bicycles 102₁ 102₂ 102₃ 102₄ has an identifier associated with it, where each identifier can be used to uniquely identify a respective bicycle 102₁ 102₂ 102₃ 102₄. It is appreciated that the length of the identifier may be any suitable length alpha and/or numeric number, binary number, hexadecimal number and the like. It is appreciated that in the specific and non-limiting examples presented in this document, the identifiers “00001”, “00002”, “00003” and “00004” are used for illustrative purposes only and the identifiers may be in some implementations serial numbers, MAC addresses, IP addresses, any other suitable network addresses, or any other suitable identifiers.

### Bicycles Collect Data

Referring back to FIG. 1, a specific and non-limiting example of how each of the four bicycles 102₁ 102₂ 102₃ 102₄ collects data will be described. This example is a continuation, at least in part, of the previous example regarding the bicycles 102₁ 102₂ 102₃ registered with the server 108 and having unique identifiers.

As previously discussed, the electronic device 300ᵢ has one or more sensors 308. In this example the sensors 308 include a GPS and Barometer for detecting latitude, longitude and elevation as function of time. Although this example is limited to GPS and Barometer for detecting latitude, longitude and elevation as function of time, it is appreciated that this example could equally apply to other types of sensors 308 (such as those listed elsewhere in this document) for collecting other suitable metrics related to the use of bicycle 102ᵢ (such as those listed elsewhere in this document). In this example, when position information (e.g., latitude, longitude and elevation data) is recorded the date and time of obtaining this position information is also record. The date and time date may be obtained by the GPS, from a real-time clock (RTC) or any other suitable device. In this example the sensors 308 also includes a motion sensor for detecting when the bicycle 102ᵢ is in motion.

It is appreciated that this example is a simplified example of information that may be determined by the electronic device 300ᵢ In other cases, the electronic device 300ᵢ may be configured such that the GPS and Barometer determine latitude, longitude and elevation as function of time and the electronic device 300ᵢ is also configured such that orientation, speed, weather data and/or linear acceleration is also determined. It is appreciated that in some cases, the latitude, longitude, elevation and time may be obtained from the GPS. In other cases, elevation may be obtained from an accelerometer, gyroscope, barometer and/or magnetometer. Orientation in space may be obtained from a gyroscope, accelerometer and/or magnetometer. Speed may be obtained from a speedometer, which may monitor the frequency of an alternator. It is appreciated that relative position may be obtained from the gyroscope, accelerometer, magnetometer and/or speedometer. Weather data may also be obtained via the GPS or a Wi-Fi connection, which originate from public servers (e.g., The Weather Network). In some cases, the barometer data may be cross-referenced with the weather data to get local data which is possibly more specific. Linear acceleration may be obtained by the accelerometer and altitude from the barometer. In some cases an ultra-sonic detector may be used for blind-spot monitoring. For example, one or more rear-facing range sensors, such as ultrasonic sensors, can be mounted to the frame of the bicycle. Processor 302 can be configured to receive and process data from such sensors to determine whether an object—such as a vehicle—is present within the range (e.g. within about three meters) of the sensors. When the determination is affirmative, processor 302 can control an output device, such as motors 291, visual indicators 210, or both, to generate a warning to the operator of bicycle 102.

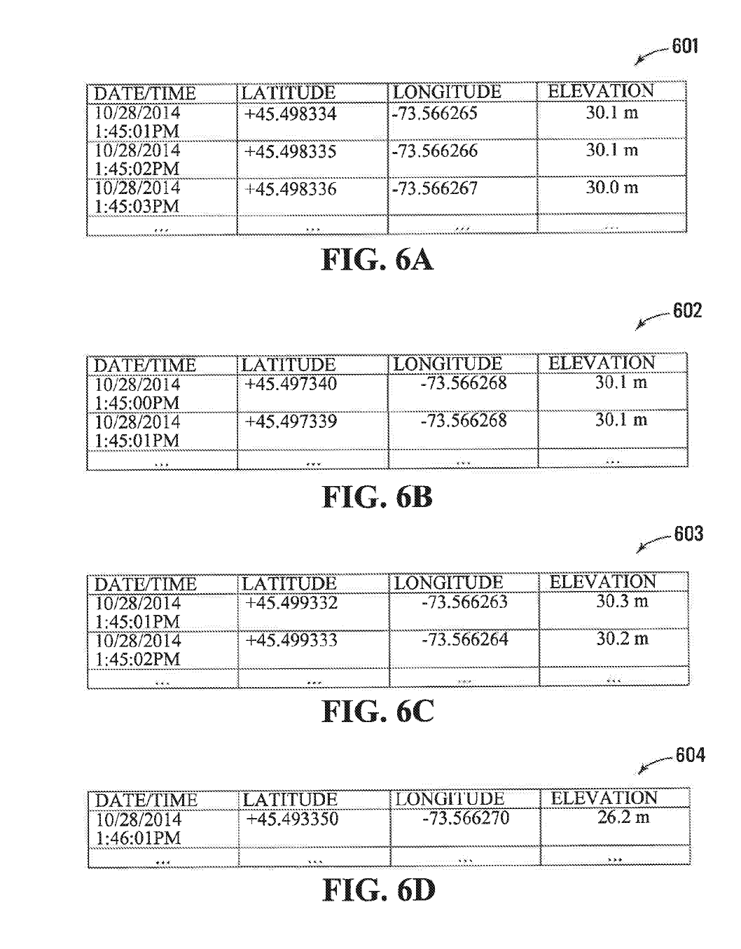

When the bicycle 102₁ is in motion, the motion sensor in the electronic device 300₁ detects that bicycle 102₁ is in motion and that position information (e.g., latitude, longitude and elevation data) may be measured and recorded. The position information can be obtained from the sensors 308 of the electronic device 300₁ and then stored in a database in the computer readable memory 304 of the electronic device 300₁. FIG. 6A illustrates an example of a record 601 which may be stored in the computer readable memory 304 of the electronic device 300₁. As illustrated in record 601, the position information (e.g., latitude, longitude and elevation data) of the bicycle 102₁, when the bicycle 102₁ is in motion, is stored as a function of date and time. More specifically, record 601 illustrates that on:
10/28/2014 at 1:45:01 PM the latitude, longitude and elevation of the bicycle 102₁ is +45.498334, −73.566265, and 30.1 m, respectively;
10/28/2014 at 1:45:02 PM the latitude, longitude and elevation of the bicycle 102₁ is +45.498335, −73.566266, and 30.1 m, respectively; and
10/28/2014 at 1:45:03 PM the latitude, longitude and elevation of the bicycle 102₁ is +45.498336, −73.566267, and 30.0 m, respectively.

In this example, the position information is recorded every one second; however, it is appreciated that the position information may be recorded at any other suitable interval (e.g., every millisecond, every microsecond, every couple of seconds, every minute, every couple of minutes, every hour, and the like). Furthermore, in this example only three data points at three different times are illustrated; however, it is appreciated that the position information recorded in the computer readable memory 304 of the electronic device 300₁ would typically contain more than three different data points and would contain data points at intervals over a period of time corresponding to the time the bicycle 102₁ is moving.

Similarly, FIG. 6B illustrates an example of a record 602 which may be stored in the computer readable memory 304 of the electronic device 300₂. As illustrated in record 602, the position information (e.g., latitude, longitude and elevation data) of the bicycle 102₂, when the bicycle 102₂ is in motion, is stored as a function of date and time. More specifically, record 602 illustrates that on:
10/28/2014 at 1:45:00 PM the latitude, longitude and elevation of the bicycle 102₂ is +45.497340, −73.566268, and 30.1 m, respectively; and
10/28/2014 at 1:45:01 PM the latitude, longitude and elevation of the bicycle 102₂ is +45.497339, −73.566268, and 30.1 m, respectively.

As in the example above, it is appreciated that in this example the position information is not limited to the time interval and number of data points illustrated.

Similarly, FIG. 6C illustrates an example of a record 603 which may be stored in the computer readable memory 304 of the electronic device 300₃. As illustrated in record 603, the position information (e.g., latitude, longitude and elevation data) of the bicycle 102₃, when the bicycle 102₃ is in motion, is stored as a function of date and time. More specifically, record 603 illustrates that on:
10/28/2014 at 1:45:01 PM the latitude, longitude and elevation of the bicycle 102₃ is +45.499332, −73.566263, and 30.3 m, respectively; and
10/28/2014 at 1:45:02 PM the latitude, longitude and elevation of the bicycle 102₃ is +45.499333, −73.566264, and 30.2 m, respectively.

As in the example above, it is appreciated that in this example the position information is not limited to the time interval and number of data points illustrated.

Similarly, FIG. 6D illustrates an example of a record 604 which may be stored in the computer readable memory 304 of the electronic device 300₄. As illustrated in the record 604, the position information (e.g., latitude, longitude and elevation data) of the bicycle 102₄, when the bicycle 102₄ is in motion, is stored as a function of date and time. More specifically, record 604 illustrates that on 10/28/2014 at 1:46:01 PM the latitude, longitude and elevation of the bicycle 102₄ is +45.493350, −73.566270, and 26.2 m, respectively. As in the example above, it is appreciated that in this example the position information is not limited to the time interval and number of data points illustrated.

It is appreciated that such a configuration of the electronic device 300ᵢ of the bicycle 102ᵢ allows for the collecting of data relating to suitable metrics to the use of bicycles 102ᵢ when the bicycle 102ᵢ is in motion. Such data may then be transmitted, directly or indirectly, to other electronic devices 300 associated with other bicycles 102 or to a server 108 for storage. In addition, the data may also be accessed by a user using the bicycle 102ᵢ in real-time via a portable electronic device (e.g., cell phone, tablet, and the like) connected to the electronic device 300ᵢ or by the user at a later time by accessing the electronic device 300ᵢ or the server 108.

It is also appreciated that the computer readable memory 304 of the electronic device 300ᵢ may have a limited capacity and may only keep track of position information for a limited amount of time. For example, the electronic device 300ᵢ may only keep track of the last 4 hours of bicycle use data. While in other cases, the electronic device 300ᵢ may only keep track of more or less than the last 4 hours of bicycle use data. Yet in other cases, the electronic device 300ᵢ keeps track of bicycle use data until the electronic device 300ᵢ is able to directly or indirectly connect with the server 108 and if the computer readable memory 304 is full prior to connecting with the server 108, deleting part of the oldest bicycle use data to make room for new bicycle use data.

### Bicycles Connect to Each Other

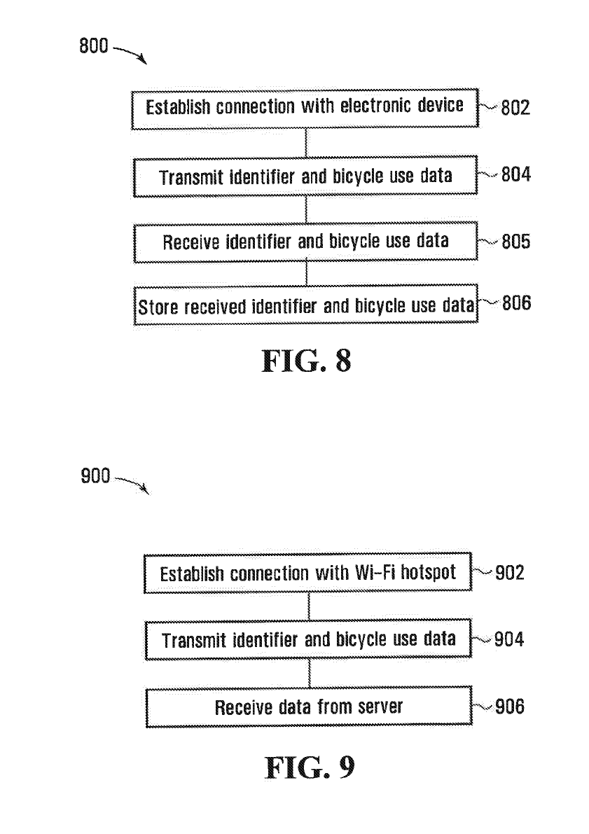

Referring back to FIG. 1, a specific and non-limiting example of how the bicycle 102₁ connects with the bicycle 102₂ and the bicycle 102₃ will be described. This example is a continuation, at least in part, of the previous example regarding the bicycles 102₁ 102₂ 102₃ collecting data, being registered with the server 108 and having unique identifiers. Turning now to FIG. 8, this figure illustrates a flowchart 800 for the process which the electronic device 300₁ of bicycle 102₁ and the electronic device 300₂ of bicycle 102₂ connect and exchange information with each other. For the sake of this example, the communication module 306 of the electronic devices 300₁ 300₂ 300₃ communicate with each other using Wi-Fi protocol. More specifically, in this example, the communication module 306 of the electronic devices 300₁ 300₂ 300₃ may function as Wi-Fi routers which wirelessly bridge which each other when in range of each other. The range that electronic devices 300₁ 300₂ 300₃ may connect with each other may vary and, in some cases, the range is about 100 meters, while in other cases, the range is less than or more than 100 meters.

In this specific example, it is assumed that the electronic device 300₁ of the bicycle 102₁ is not connected to the wireless network access point 104₁ over the wireless link 115₁, that at a first point of time (t=1) the electronic device 300₁ of the bicycle 102₁ connects to the electronic device 300₂ of the bicycle 102₂, and that at a second point of time (t=2) the electronic device 300₁ of the bicycle 102₁ connects to the electronic device 300₃ of the bicycle 102₃.

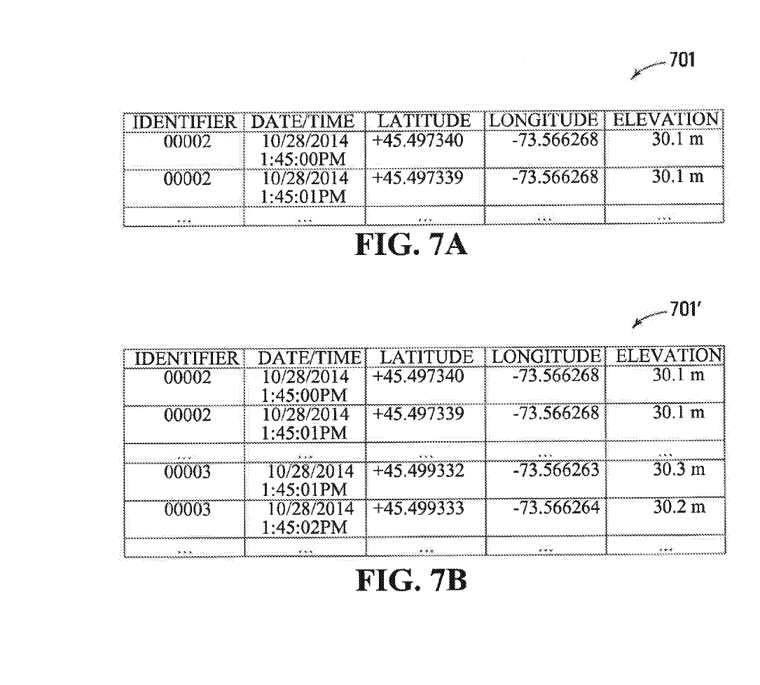

At a first point of time (t=1) when the two bicycles 102₁ 102₂ are in a wireless connectivity range of each other, the two bicycles 102₁ 102₂ may connect to each other according to the steps of the flowchart 800. At step 802, the electronic device 300₁ of the bicycle 102₁ connects to the electronic device 300₂ of the bicycle 102₂ over the wireless link 116₁. This step may include an authentication protocol to facilitate the connection. At step 804 the electronic devices 300₁ transmits its identifier and some or all of the data stored relating to the metrics related to the use of bicycles 102 or any other suitable data stored in the computer readable memory 304 of electronic devices 300₁ to the electronic devices 300₂. At step 805 the electronic devices 300₁ obtains from the electronic devices 300₂ the identifier of the electronic devices 300₂ and some or all of the data stored relating to the metrics related to the use of bicycles 102 or any other suitable data stored in the computer readable memory 304 of electronic devices 300₂. This exchange of identifiers and data may take place in a half-duplex communication, in which the electronic device 300₁ first communicates its identifier and data to the electronic device 300₂ and then the electronic device 300₂ later communicates its identifier and data to the electronic device 300₁. Then at step 806 the received data and identifier can then be stored in the computer readable memory 304 of each respective electronic device 300₁ 300₂. FIG. 7A illustrates an example of table 701 stored in the database of the computer readable memory 304 of the electronic device 300₁. As illustrated in the table 701, the position information (e.g., latitude, longitude and elevation data) of the bicycle 102₂ is stored in association with the identifier “00002” of the electronic device 300₂ of the bicycle 102₂. Although not illustrated, similarly the computer readable memory 304 of the electronic device 300₂ could also store in association with the identifier “00001” of the electronic device 300₁ some or all of the data stored relating to the metrics related to the use of bicycles 102₁.

At a second point of time (t=2) when the two bicycles 102₁ 102₃ are in a wireless connectivity range of each other, the two bicycles 102₁ 102₃ may connect to each other according to the steps of the flowchart 800. Similar to the steps in the example above, the electronic devices 300₁ 300₃ of the two bicycles 102₁ 102₃ would establish a connection over the wireless link 116₂, exchange identifiers and data, and store the data in association with respective identifiers. FIG. 7B illustrates an example of table 701′ stored in the database of the computer readable memory 304 of the electronic device 300₁. As illustrated in the table 701′, the position information (e.g., latitude, longitude and elevation data) of the bicycle 102₂ previously obtained is stored in association with the identifier “00002” of the electronic device 300₂ of the bicycle 102₂ and the position information (e.g., latitude, longitude and elevation data) of the bicycle 102₃ currently obtained is stored in association with the identifier “00003” of the electronic device 300₃ of the bicycle 102₃. Although not illustrated, similarly the computer readable memory 304 of the electronic device 300₃ could also store in association with the identifier “00001” of the electronic device 300₁ some or all of the data stored relating to the metrics related to the use of bicycles 102₁ and store in association with the identifier “00002” of the electronic device 300₂ some or all of the data stored relating to the metrics related to the use of bicycles 102₂.

Although in the example above the communication modules 306 of the electronic devices 300₁ 300₂ 300₃ use Wi-Fi protocol, any other suitable communication protocol could be used (as discussed elsewhere in this document).

In other cases, instead of exchanging data relating to historic metrics of use of the bicycles, each of the electronic devices 300₁ 300₂ 300₃ may record the current position information (e.g., latitude, longitude and elevation data) of each other's bicycles when in range of each other. For example, when the electronic device 300₁ is in range of the electronic device 300₂, the electronic devices 300₁ could record the identifier “00002” of the electronic device 300₂, and the current position information (e.g., latitude, longitude and elevation data) of the bicycle 102₂ associated with the identifier “00002” of the electronic device 300₂, along with the date and time of this interaction. Similarly, in this example, the electronic devices 300₂ could also record the identifier “00001” of the electronic device 300₁, and the current position information (e.g., latitude, longitude and elevation data) of the bicycle 102₁ associated with the identifier “00001” of the electronic device 300₁, along with the date and time of this interaction.

As discussed in the example above, the first electronic devices 300₁ may exchange its identifier and possibly some or all of the data stored relating to the metrics related to the use of bicycles 102 or any other suitable data stored in the computer readable memory 304 of the first electronic devices 300₁ to the second electronic devices 300₂. However, in other cases, only the identifier of the electronic devices 300 may be exchanged. Yet in other cases, when certain conditions are met, in addition to the identifier of the electronic devices 300 being exchanged, other information relating to use of the bicycles 102 may be exchanged.

### Bicycles Connect to Wi-Fi Access Point

Referring back to FIG. 1, a specific and non-limiting example of how the bicycle 102₁ connects to the wireless network access point 104₁ and how the bicycle 102₄ connects to the wireless network access point 104₂ to transmit data relating to the metrics related to the use of bicycles 102₁ 102₂ 102₃ 102₄ will now be described. This example is a continuation, at least in part, of the previous examples regarding the bicycles 102₁ 102₂ 102₃ 102₄ collecting data and the bicycles 102₁ obtaining data from the bicycles 102₂ 102₃. Turning now to FIG. 9, this figure illustrates a flowchart 900 for the process which one of the electronic devices 300 of one of the bicycles 102 can connect to one of the wireless network access points 104, when in range. In this example, the wireless network access points 104 are implemented as Wi-Fi hotspots. The range of the Wi-Fi hotspots may vary and, in some cases, the range is about 100 meters, while in other cases, the range is less than or more than 100 meters.

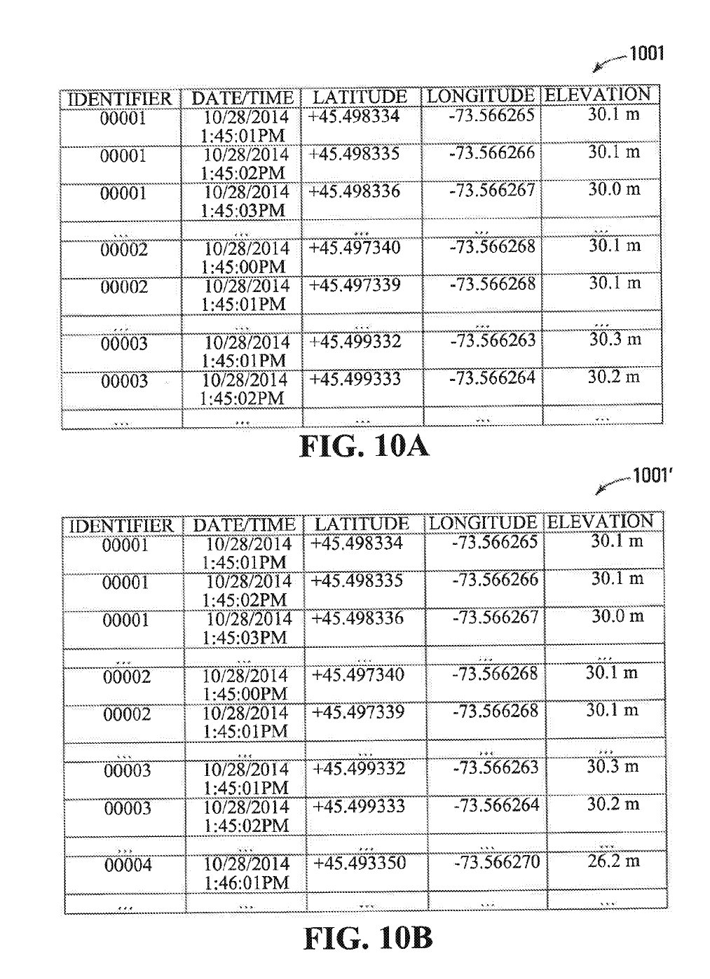

In this example, at step 902 the bicycle 102₁ connects to the wireless network access point 104₁ over a wireless link 115₁ between the communication module 306 of the electronic device 300₁ and the Wi-Fi access device 510 of the wireless network access point 104₁. This step may include an authentication protocol to facilitate the connection. Then as step 904 the electronic device 300₁ transmits the data it has stored relating to the use of the various bicycles 102₁ 102₂102₃ to the wireless network access point 104₁. Then the wireless network access point 104₁ transmits the received information to the server 108 via the data network 106. The server 108 can then store the received information in the database 408 of the computer readable memory 404. FIG. 10A illustrates an example of record 1001 stored in the database 408 of the computer readable memory 404 of the server 108. As illustrated in the record 1001, the position information (e.g., latitude, longitude and elevation data) of the bicycles 102₁ 102₂ 102₃ is stored in association with the respective identifiers “00001” “00002” “00003”. Then at step 906 the server 108 may send any relevant data or commands, which is received at the electronic device 300₁. For example, this relevant information may include identifiers of stolen bicycles, software updates, acknowledgement that the data relating to the use of the bicycles 102₁ 102₂ 102₃ is received, traffic updates, route suggestions, road surface conditions, cycling lanes, information relating to a planned route, previous routes taken, or any other relevant data. In some cases, the electronic device 300₁ downloads from the server 108 a record of unique identities of the stolen bicycles that the server 108 has determined to possibly be in the nearby vicinity of the bicycle 102₁. This may enables the electronic device 300₁ to cross-reference the bicycles 102 that it communicates with to determine if they are stolen or not-stolen. When the electronic device 300₁ receives acknowledgement that data is received, then the electronic device 300₁ may delete the data stored in the database in the computer readable memory 304 corresponding to the data transmitted to the server 108.

It is appreciated that such a configuration may allow for various data relating to the use of the various bicycles 102₁ 102₂ 102₃ to be shared among the bicycles 102₁ 102₂ 102₃ when none of the bicycles 102₁ 102₂ 102₃ are in range of the wireless network access points 104 such that when one of the bicycles 102₁ 102₂ 102₃ does enter range of one of the wireless network access points 104 that the various data relating to the use of the various bicycles 102₁ 102₂ 102₃ is transmitted to the server 108.

Furthermore, in this example, the process 900 can be repeated for the bicycle 102₄. At step 902 the bicycle 102₄ connects to the wireless network access point 104₂ over a wireless link 115₂ between the communication module 306 of the electronic device 300₄ and the Wi-Fi access device 510 of the wireless network access point 104₂. Then at step 904 the electronic device 300₄ transmits the data it has stored relating to the use of bicycle 102₄ to the wireless network access point 104₂. Then the wireless network access point 104₂ transmits the received information to the server 108 via the data network 106. The server 108 can then store the received information in the database 408 of the computer readable memory 404. FIG. 10B illustrates an example of record 1001′ stored in the database 408 of the computer readable memory 404 of the server 108. As illustrated in the record 1001′, the position information (e.g., latitude, longitude and elevation data) of the bicycles 102₁ 102₂ 102₃ previously obtained is stored in association with the respective identifiers “00001” “00002” “00003” and the position information (e.g., latitude, longitude and elevation data) of the bicycle 102₄ currently obtained is stored in association with the identifier “00004”. Then as step 904 the server may send any relevant data or commands to the electronic device 300₄.

It is appreciated that such a configuration may allow for the server 108 to record data relating to various bicycles 102₁ 102₂ 102₃ 102₄ when only select bicycles (in this example above bicycles 102₁ 102₄) come into range of a Wi-Fi hotspot. In other words, in this example, the server 108 obtained data relating to the use of the bicycles 102₁ and 102₄ directly from the bicycles 102₁ and 102₄ and obtained data relating to the use of the bicycles 102₂ and 102₃ indirectly via bicycle 102₁.

It is also appreciated that such a configuration may allow for the electronic devices 300₁ 300₂ 300₃ 300₄ to communicate amongst each other without the use of an external communication device (such as a mobile or cellular telephone). It is also appreciated that such a configuration may allow for one or more of the electronic devices 300₁ 300₂ 300₃ 300₄ when in range of one of the wireless network access points 104₁ 104₂ to communicate with the server 108 via one of the wireless network access points 104₁ 104₂ and the data network 106 without the use of an external communication device (such as a mobile or cellular telephone).

In the examples above, it is assumed that the electronic device 300₁ of the bicycle 102₁ is not connected to the wireless network access point 104₁ over the wireless link 115₁ when the electronic device 300₁ of the bicycle 102₁ connects to the electronic devices 300₂ 300₃ of the respective bicycle 102₂ 102₃ via respective wireless links 116₁ 116₂ and vice versa. However, in other embodiments, the electronic device 300₁ of the bicycle 102₁ connects to both the electronic devices 300₂ 300₃ of the respective bicycle 102₂ 102₃ while being connected to the wireless network access point 104₁. In these embodiments, where the electronic device 300₁ of the bicycle 102₁ is connected to the wireless network access point 104₁ over the wireless link 115₁, is also connected to the electronic device 300₂ 300₃ over the respective wireless links 116₁ 116₂, wireless bridges are formed between the electronic devices 300₁ 300₂ 300₃ which may allow for data to be transmitted from either of the electronic devices 300₂ 300₃ not directly connect to the wireless network access point 104₁ via the electronic devices 300₁ which is connect to the wireless network access point 104₁. Then the data at the wireless network access point 104₁ can be transmitted to the server 108 via the data network 106.

It is appreciated that such a wireless bridge configuration of the mesh network may allow for bicycles 102₂ 102₃ out of range of the wireless network access points 104₁ 104₂ to connect to the server 108 via the bicycle 102₁ that is in range of the wireless network access points 104₁. In other words, the communication modules 306 of the electronic devices 300₁ 300₂ 300₃ function as Wi-Fi routers which wireless bridges with each other, to possibly extent the range of the network 100.

It is also appreciated that such a configuration may allow the bicycle 102₄ which is out of range of a wirelessly connected group of bicycles 102₁ 102₂ 102₃ to connect to the wirelessly connected group of bicycles 102₁ 102₂ 102₃, as the range of the network 100 may extend across all wireless network access points 104₁ 104₂ and all groups of connected bicycles (e.g., the first group of wirelessly connected bicycles 102₁ 102₂ 102₃ and the second group of wirelessly connect bicycles 102₄) connect to the wireless network access points 104₁ 104₂.

In these examples, the wireless network access points 104 which are implemented as Wi-Fi hotspots may be open public network hotspots or closes public network hotspots which may use a hotspot management system to control access (as discussed elsewhere in this document). By way of example, if the wireless network access point 104₁ is an open public network Wi-Fi hotspot the electronic device 300₁ would be able to connect to the wireless network access point 104₁ to gain access to the data network 106 and to the server 108 without having to provide any authentication, other than connecting using Wi-Fi protocol to the wireless network access point 104₁. By way of another example, if the wireless network access point 104₂ is a closed public network Wi-Fi hotspot employing a hotspot management system, the electronic device 300₄ would typically be able to connect to the wireless network access point 104₂ using Wi-Fi protocol but would typically have to provide additional information to the hotspot management system in order to gain access to the close public network of the wireless network access point 104₂ and then connect to the server 108 via the data network 106. In this example, the additional information may be a username and/or password, or any other suitable indicator which may be stored in the computer readable memory 304 of the electronic device 300₄.

It is also appreciated that in the examples above when the data is transmitted to the server 108, that the server 108 may require a form of authentication (e.g., username and/or password, or any other suitable indicator) to authenticate the user and/or electronic device 300 that the data is being transmitted from.

In these examples, once an electronic device 300ᵢ associate with the bicycle 102ᵢ is connected to the server via a wireless network access point 104ᵢ, the electronic device 300ᵢ periodically may update the server 108 with the bicycle use data relating to the bicycle 102ᵢ and any other bicycle use data that the bicycle 102ᵢ obtains from the electronic devices 300 associate with other bicycles 102.

### Bicycles Connects to Cellular Access Point

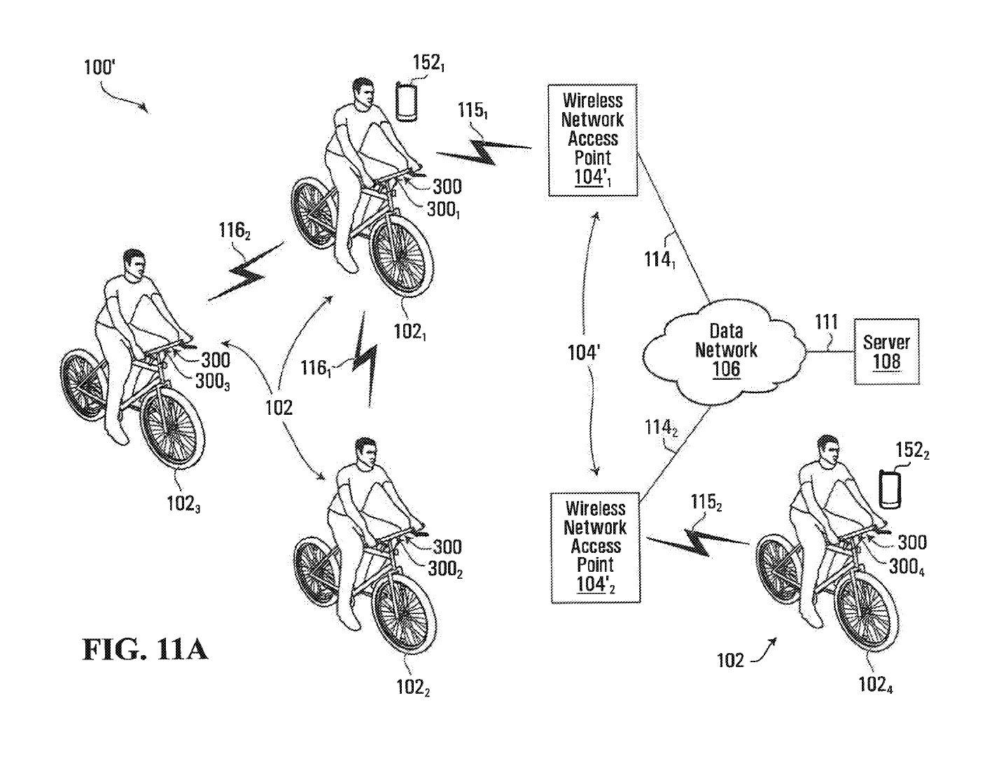

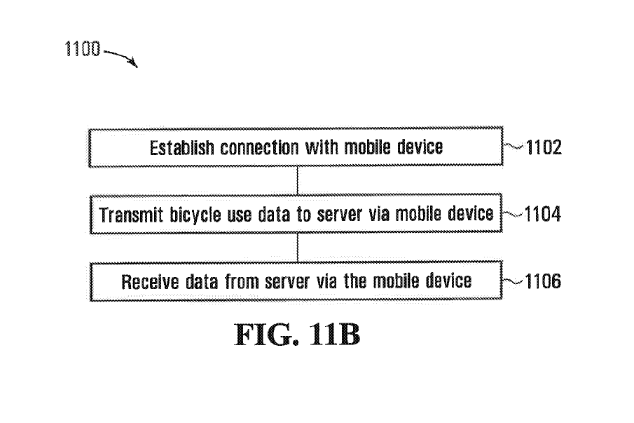

FIG. 11A shows a set of network-enabled bicycles 102 where portable communication devices 152₁ 152₂ may be used to connect to one of the cellular network access points 104′ in accordance with a specific non-limiting implementation. As shown, the plurality of network-enabled bicycles 102 may be connected directly or indirectly to one another and/or connected directly or indirectly to one of a plurality of wireless network access points 104′ via one of the portable communication devices 152₁ 152₂. The wireless network access points 104′ are in turn in communication with a server 108 over a data network 106.

The network 100′ shown in FIG. 11A is a variant of the network 100 shown in FIG. 1, where an external communication device 152₁ is provided for connecting with the electronic device 300₁ of the bicycle 102₁ and an external communication device 152₂ for connecting with the electronic device 300₄ of the bicycle 102₄. Furthermore, the network 100′ includes one or more wireless network access points 104′ where the access points 104′ are cellular network access points that allow the external communication devices 152₁ 152₂ to connect via a cellular network protocol(s) (as discussed elsewhere in this document). More specifically, in this example, the external communication device 152₁ is a mobile phone (but could be a tablet or any other suitable portable communication device) that connects to the access point 104′₁ using a cellular protocol and the external communication device 152₂ is a mobile phone (but could be a tablet or any other suitable portable communication device) that connects to the access point 104′₂ using a cellular protocol.

This example is a continuation, at least in part, of the previous examples regarding the bicycles 102₁ 102₂ 102₃ 102₄ collecting data and the bicycles 102₁ obtaining data from the bicycles 102₂ 102₃. Turning now to FIG. 11B, this figure illustrates a flowchart 1100 for the process for which the electronic device 300ᵢ of the bicycle 102ᵢ may use to connect to one of the wireless network access points 104′.

In this example, at step 1102 the communication module 306 of the electronic device 300₁ connects to the external communication device 152₁ which may take place over Bluetooth protocol (or any other suitable protocol, as discussed elsewhere in this document). As the external communication device 152₁ is connected via a cellular network protocol to the wireless network access point 104′₁, then at step 1104 the communication module 306 of the electronic device 300₁ can communicate to the external communication device 152₁ which can then transmit the data to the wireless network access point 104′₁. At this step the data transmitted may include the data stored relating to the use of the various bicycles 102₁ 102₂ 102₃ to the wireless network access point 104₁, similar to the data transmitted in step 904 of the example above. Then the wireless network access point 104′₁ transmits the received information to the server 108 via the data network 106. The server 108 can then store the received information in the database 408 of the computer readable memory 404. Then as step 1106 the server 108 may send any relevant data or commands to the electronic device 300₁ via the wireless network access point 104′₁ and the external communication device 151₁.

Similarly, the electronic device 300₄ of the bicycle 102₄ may connect to the wireless network access point 104′₂ via the external communication device 152₂ and then transmit and receive data from the server 108.

It is appreciated that in some embodiments of the invention that some of the wireless network access points 104 may be implemented as Wi-Fi hotspots and some of the wireless network access points 104′ may be implemented as cellular network access points. Such a configuration may allow a set of users of the bicycles 102 that wish to use their cellular phones or other mobile communication devices to be able to communicate with the server 108 via their cellular phones or other mobile communication devices, while allowing another set of users of the bicycle 102s that are not making use of cellular phones or other mobile communication devices to connect via Wi-Fi hotspots. Such a configuration may allow a set of the communication devices 300 of the bicycles 102 to communicate with each other over Wi-Fi regardless of which set of the communication devices 300 are connected to one of the wireless network access points 104 104′ or the type of wireless network access point (e.g., Wi-Fi or cellular).

### Viewing Position Information

The owner of the bicycle 102ᵢ may connect with a computing device (e.g., cell phone, tablet, computer, and the like) to the server 108 over the data network 106 (e.g., the Internet) via a web browser or any other suitable application (e.g., mobile phone application). The owner may be prompted to provide credential information to login to the server 108 to view information associated with the user's account. Once the user has authenticated himself/herself to the server 108, the user can then request to view position information associated with one of the bicycles 102 associated with the user's account. FIG. 19 illustrates a process 1900 that may be implemented by the server 108 when a user makes a request to view position information associated with a bicycle 102ᵢ associated with the user's account. To illustrate the process 1900, an example is given below where the owner of the bicycle 102₁ desires to view the position information associated with his bicycle 102₁. At step 1902 the server 108 receives an indication for position information of a bicycle 102₁ associated with the identifier “00001” of the bicycle 102₁. This indication may be the user entering in a serial number associated with the user's bicycle 102₁, the user selecting a bicycle already registered with the user's account or the user entering in the identifier “00001” of the bicycle 102₁. For this example, it is assumed that the server 108 provides the user with a list of one or more bicycle 102 associated with the user's account, from which the user can then select the bicycle 102₁ that user desires to obtain position information from. Then when the user selects the bicycle 102₁, the server 108 is able to obtain the identifier “00001” of the bicycle 102₁ from the user's account information. Then at step 1904, the server 108 can process the records of position information stored in the database 408 of the computer readable memory 404. At this step, this processing may include the server taking the identifier “00001” associated with the bicycle 102₁ that the user requested position information about and locating all records associated with the identifier “00001”. It is appreciated that the user may specify a specific timeframe for which position information is to be obtained, and in this case the server 108 would limit its search and results to the specific timeframe. Then at step 1906 the server 108 provides the user with the position information. The position information may be displayed on a graphical display of the owner's computing device, which may include overlapping the position information on a map along with the date/time of the position information.

It is appreciated that such a configuration may allow for a user to view in real-time the position information of a bicycle 102ᵢ as the server 108 can continue to obtain position information from the bicycle 102ᵢ as long as the bicycle 102ᵢ is connected directly or indirectly to the server 108.

### Bicycle Recovery System

Referring back to FIG. 1, specific and non-limiting examples of how position information of the bicycles 102₃ may be obtained when the bicycle 102₃ is stolen will now be described. In these examples, it is assumed that the bicycle 102₃ has been stolen and the owner of the bicycle 102₃ would like to obtain the position information and the date/time of the position information of the bicycle 102₃.

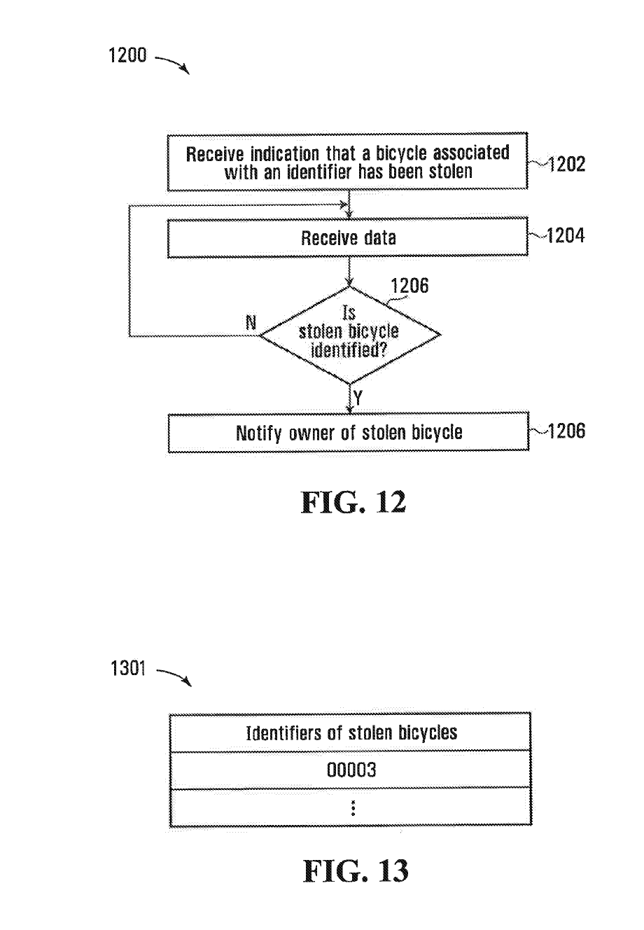

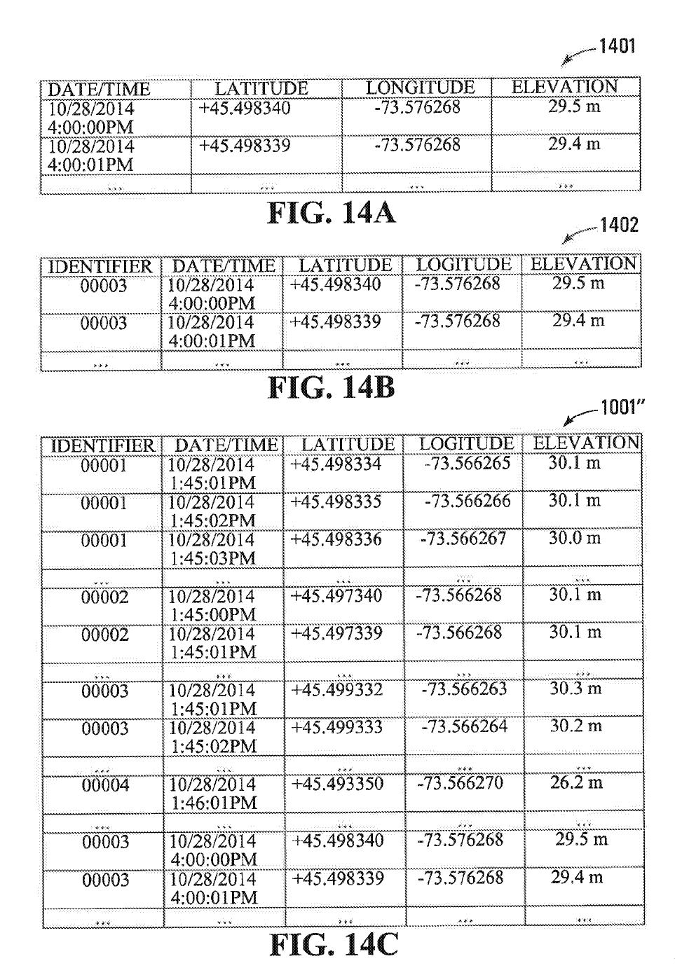

Turning now to FIG. 12, this figure illustrates a flowchart 1200 for the process which the server 108 may follow when the server 108 receives a notification that a bicycle has been stolen. At step 1202, the server receives an indication that a bicycle associated with an identifier has been stolen. In this example, the owner of bicycle 102₃ has learned that his bicycle 102₃ has been stolen and connects to the server 108 over the data network 106 (e.g., the Internet) via a computing device (e.g., a computer, cell phone, tablet or the like). The owner may also authenticate himself to the server 108. This authentication may include the user entering in some credential information such as a username and password associated with the user and/or associated with the bicycle identifier “00003” of the user's bicycle 102₃. The user can then send an indication to the server 108 that the bicycle 102₃ associated with the electronic device 300₃ and the identifier “00003” has been stolen. In some cases, the user may have a mobile application running on a computing device (e.g., mobile phone, tablet or other suitable device) which the user uses to notify the server of the stolen bicycle. Then the server 108 may add the received identifier “00003” to a list of identifiers corresponding to stolen bicycles. FIG. 13 illustrates an example of a table 1301 of identifiers corresponding to stolen bicycles which may be stored in the database 408 of the server 108. As illustrated in table 1301 the identifier “00003” is listed in the table of stolen bicycles.

At step 1204, the server 108 continues to receive data from the bicycles 102 in the fashion similar to the examples discussed elsewhere in this document where the one or more of the bicycles 102 connects to wireless network access points 104 (or 104′).

In this example, once the bicycle 102₃ starts to move (e.g., based on output from a motion sensor), the electronic device 300₃ starts to record position information (e.g., longitude, latitude, and elevation data) along with the date/time. FIG. 14A illustrates an example of the position information that the bicycle 102₃ may record in the computer readable memory 304 of the electronic device 300₃. If the electronic device 300₃ is unable to connect to the server 108 directly via one of the wireless network access points 104, the electronic device 300₃ continues to record position information. On the other hand, if the electronic device 300₃ is able to connect to the server 108 via one of the wireless network access points 104, the position information may be communicated to the server 108.

In the case where electronic device 300₃ is unable to connect to the server 108 directly or indirectly via one of the wireless network access points 104 or through one of the other electronic devices 300₁ 300₂ 300₄, the electronic device 300₃ continues to record position information.

Now in this example, the electronic device 300₁ of the bicycle 101₁ comes into wireless connectivity range of the electronic device 300₃ of the bicycle 102₃ and the bicycle 101₁ can obtain the position information of bicycle 102₃ including the date/time of the position information and the identifier “0003” of the bicycle 102₃ associated with the position information. FIG. 14B illustrates an example of the position information that the bicycle 102₁ may record in the computer readable memory 304 of the electronic device 300₁ after obtaining this position information from the bicycle 102₃. In this example, it is assumed at this point in time that the electronic device 300₁ is not yet connected to the wireless network access point 104₁ via the wireless link 115₁.

Then when the bicycle 101₁ comes into wireless connectivity range of the wireless network access point 104₁, the electronic device 300₁ of the bicycle 101₁ transmits the position information and the server 108 receives the data corresponding to the position information of bicycle 102₃ (step 1204). This position information can then be added to table 1001″ stored in the database 408 of the computer readable memory 404 of the server 108, where table 1001″ is an updated version of table 1001′ to include the latest obtained position information.

Although in this example, the position information is received at the server 108 via the wireless network access point 104₁ which may be implemented as a Wi-Fi hotspot. In other examples, the position information could be received at the server 108 via the wireless network access point 104′₁ which is a cellular network access point via a communication device 152₂, such as illustrated in the network 100′ of FIG. 11A. In these cases, an indirect connection with the server 108 may be made from the electronic device 300₃ to the server 108 via a Wi-Fi bridge between the electronic devices 300₃ 300₁ and via the connection between the electronic device 300₁ and the communication device 152₁. Then, the electronic device 300₃ would be able to transmit its current position information and historic position information to the server 108, including the date/time of the position information and the corresponding identifier.

In other cases, if the electronic device 300₃ enters in range of one of the wireless network access points 104 implemented as Wi-Fi hotspots, the electronic device 300₃ may connect to the server 108 via one of the wireless network access points 104 without having to communicate through one of the other electronic devices 300₁ 300₂ 300₄. Then, the electronic device 300₃ would be able to transmit its current position information and historic position information to the server 108, including the date/time of the position information and the corresponding identifier.

Then at step 1206 the server 108 checks the received data by comparing the received identifiers with the identifiers stored in the table 1301, which lists identifiers corresponding to stolen bicycles, to see if a stolen bicycle can be identified. If one of the received identifiers matches with an identifier stored in the table 1301 then the server 108 notifies the owner of the stolen bicycle corresponding to the identified identifier at step 1206. Otherwise, the server continues to monitor the incoming data. The notification to the owner of the stolen bicycle may be, for example, a text message sent to a mobile device associated with the bicycle owner, a visual indicator displayed in a mobile phone application, an email, or any other suitable electronic message to indicate to the owner that information associated with the owner's bicycle has been obtained. In some cases, the notification to the owner may include the position information. In other cases, the owner may have to login to the server 108 with a computing device and can then view the position information. Yet in other cases, the owner may view the position information in a mobile application on a mobile computing device. In these cases, the position information may be displayed on graphical display of the owner's computing device by overlapping the position information on a map along with the date/time of the position information.

In these examples, the server 108 may send a notification back to the electronic device 300₃ to indicate to the electronic device 300₃ that it is a stolen. In cases where the electronic device 300₃ receives a notification that it is stolen, the electronic device 300₃ may enter in a mode to function differently, which may include increasing the interval of obtaining position information, not deleting past route information, not obtaining routing information from other bicycle, establishing connections to Wi-Fi hotspots automatically, at the like.

In other examples, the server 108 may transmit the identifiers of stolen bicycles to the electronic devices of the bicycles which are connected to the server 108 and these bicycles may maintain a list of stolen bicycles and actively search for the stolen bicycles, which may then passed to other bicycles that are not connected to the server 108 or do not have the most up-to-date list of stolen bicycles. Then, a bicycle may then maintain the list of stolen bicycles and may then actively search by checking the identifiers of any bicycles that this bicycle makes contact with. Then, in the event that the bicycle has made contact with a stolen bicycle, the bicycle may then send the notification that a stolen bike has been located to the server 108 along with position information of the stolen bicycle. Then the server 108 may then forward this information to the owner of the identified stolen bicycle.

It is appreciated that in the examples when the mesh network 100 comprises wireless network access points 104₁ 104₂ implemented as Wi-Fi hotspots and the electronic device 300 is embedded into the bicycles 102ᵢ that the position information of the stolen bicycle may be obtained without the use of any external communication devices.

It is also appreciated that when a stolen bicycle 102ᵢ is identifier, the stolen bicycle may be provided (e.g., via the server 108 or another bicycle) with an indication that the bicycle is stolen.

Referring back to FIG. 2A, when the electronic device 300 is embedded within the handle bars 202 of the bicycle 102ᵢ, the sensors 308 (not illustrated in FIG. 2A) may include sensors for detecting tampering with the bicycle 102. The sensors may be any suitable sensors, such as those discussed elsewhere in this document. By way of example, if the bicycle 102ᵢ is locked to a bike rack and is in range of a Wi-Fi hotspot, is connected to another bicycle having either a mobile connection to a cellular access point or a connection to a Wi-Fi hotspot, or is connection to a cellular access point, the electronic device 300 may send a notification to the server 108 of physical tampering, wheel spin, vibrations, movement or any other suitable metric. The server 108 may then send a notification to the owner, via text-message, email, indication in a mobile application of a mobile device, or any other suitable electronic notification.

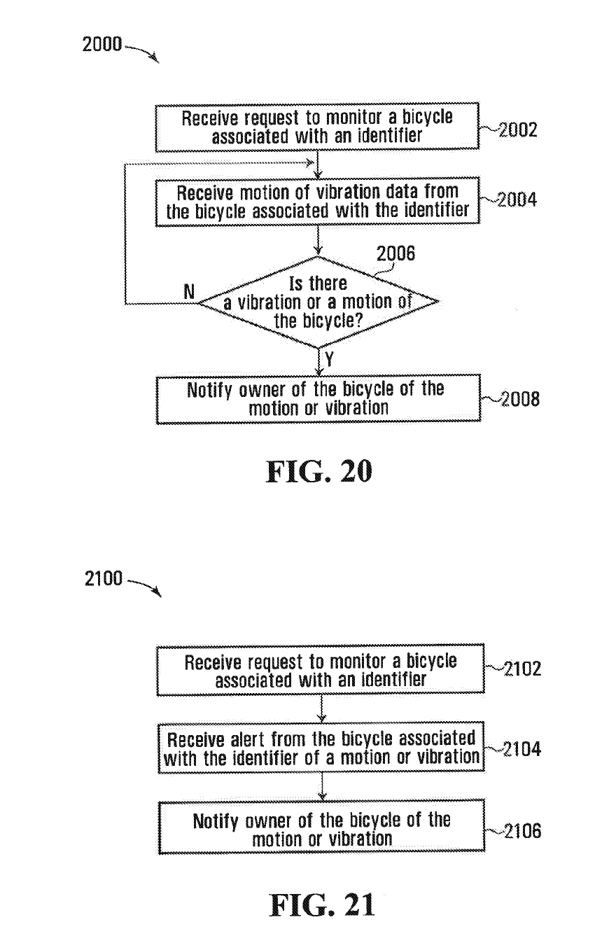

FIG. 20 illustrates a flowchart for the process 2000 which the server 108 may follow when the server 108 receives a notification that a bicycle 102ᵢ is to be monitored for motion or vibrations. At step 2002 the server 108 receives a request from a user to monitor a bicycle 102ᵢ associated with an identifier, where the bicycle 102ᵢ is connected directly or indirectly to the server 108. The server 108 may then send a notification to the electronic device 300ᵢ associated with the bicycle 102ᵢ to notify the electronic device 300ᵢ to send motion and/or vibration data. Then at step 2004 the server 108 periodically receives motion or vibration data from the electronic device 300ᵢ of the bicycle 102ᵢ. This receives motion or vibration data is then processed at step 2006 to determine if there is a vibration or a motion of the bicycle 102ᵢ. If is no vibration or a motion of the bicycle 102ᵢ, then the server 108 continues to monitor the incoming motion and vibration data, until the user sends a notification to stop monitoring the bicycle 102ᵢ associated with the specified identifier. If there is a vibration or a motion of the bicycle 102ᵢ, then the server 108 notifies the owner of the bicycle 102ᵢ of the motion or vibration at step 2008. This notification may include a text message, an indication in a mobile phone application, an email, or any other suitable electronic correspondence.

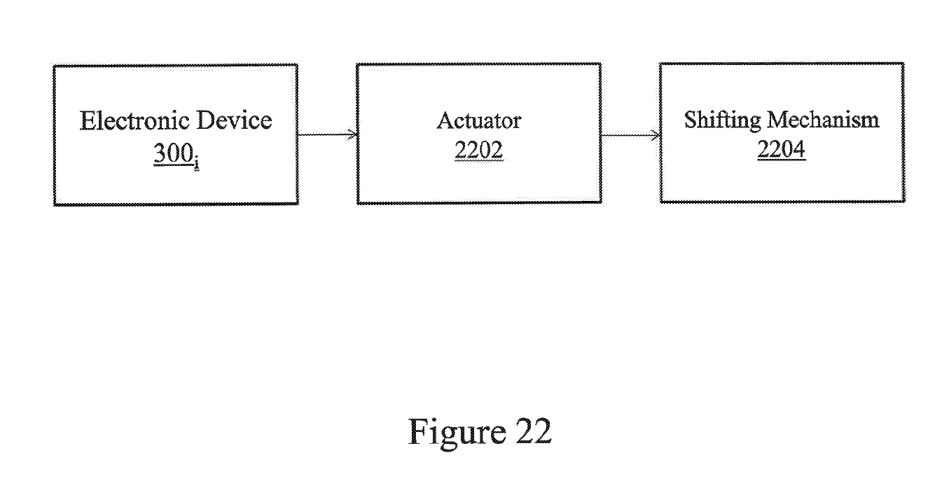

FIG. 21 illustrates a flowchart for the process 2100 which the server 108 may follow when the server 108 receives a notification that a bicycle 102ᵢ is to be monitored for motion or vibrations. The process 2100 is similar to the process 2000; however, in the process 2100 the electronic device 300ᵢ determines if there is a motion or vibration of the bicycle 102ᵢ and notifies the server 108. At step 2002 the server 108 receives a request from a user to monitor a bicycle 102ᵢ associated with an identifier, where the bicycle 102ᵢ is connected directly or indirectly to the server 108. The server 108 may then send a notification to the electronic device 300ᵢ associated with the bicycle 102ᵢ to notify the electronic device 300ᵢ to alert the server 108 if there is any suspicion motion or vibration of the bicycle 102ᵢ. Then at step 2014, if the server 108 receives an alert from the electronic device 300ᵢ of the bicycle 102ᵢ, then the server 108 notifies the owner of the bicycle 102ᵢ of the motion or vibration at step 2106. This notification may include a text message, an indication in a mobile phone application, an email, or any other suitable electronic correspondence.

It is appreciated that such a configuration may allow for an automatic alert and notification system allowing an owner of a bicycle to lock his bicycle to a bike rack (or other suitable object) which is in direct or indirect range of a wireless network access point 104 or 104′. After the user locks his bicycle, the user may then send an indication to the bicycle to entering an alert mode to send a notification if the bicycle is attempted to be stolen. This indication may be sent directly to the bicycle (e.g., via Bluetooth or Wi-Fi) or to the server 108 which then sends the indication to the bicycle. Then when the bicycle moves a motion sensor (or other suitable sensor) may detect the movement and sends a notification to the server 108 which may then notify the owner of the bicycle of such movement.

### Pot Hole Detection

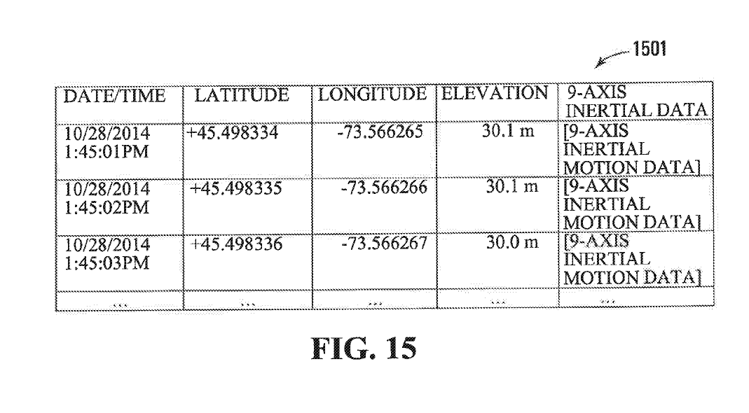

FIG. 15 illustrate an example of a record 1501 listing position information to include 9-axis inertial data. In this example, the position information obtained by the sensors 308 includes 9-axis inertial data. This 9-axis inertial data can be considered to be motion data corresponding to the yaw-pitch roll, angular velocity (in three dimensions), linear acceleration (in three dimensions) which when processed by the electronic device 300 or the server 108 may provide useful information.

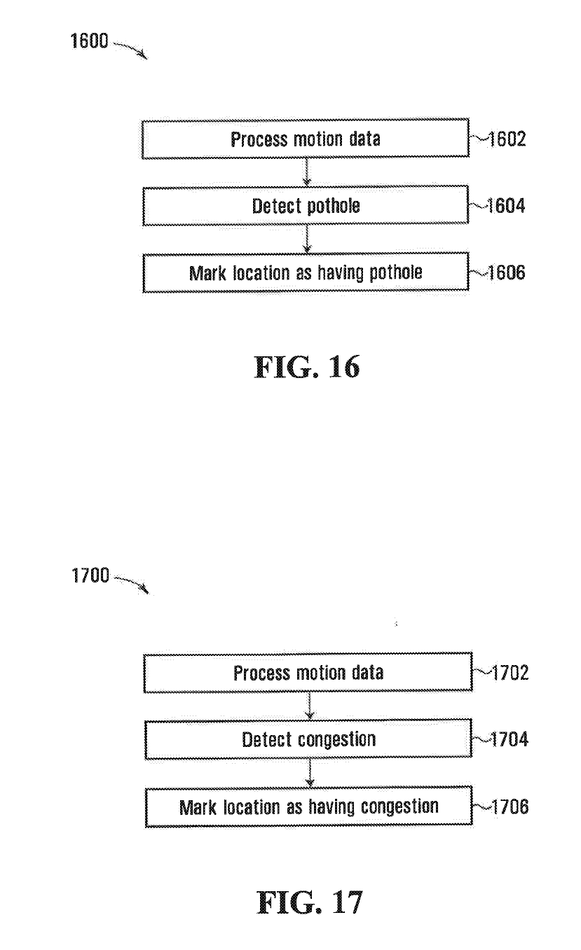

FIG. 16 illustrates a flowchart for the process which potholes may be detected in accordance with an embodiment of the invention. At step 1602 the motion data is processed. This may include processing the yaw-pitch roll, angular velocity, linear acceleration data, or any combination thereof. Then at step 1604 a pothole is detected by identifying characteristics in the motion data which may correspond to a pothole. For example, processor 302 can be configured to determine whether a vertical acceleration of the bicycle exceeded a predetermined threshold (indicating a sudden vertical drop), and detect a pothole when the determination is affirmative. Other processes can also be performed by processor 302 to detect potholes (e.g. a vertical acceleration exceeding a threshold in a first direction, followed by a vertical acceleration exceeding a threshold in a second, opposite direction, may be indicative of the sudden drop of a wheel of the bicycle into a pothole, followed by the sudden rise out of the pothole). Then at step 1606 the position information corresponding to latitude and longitude may be used to mark the location of the pothole. This marked location may then be marked on a map which may be view on a computing device by cyclists. In other cases, the position of all detected potholes may be tracked on a master list which may be shared among all of the electronic devices 300 of the bicycles 102. Then prior to approaching a pothole the cyclist may be indicated that he or she is about to ride over a pot hole, such an indication may be a sound or haptic feedback (e.g., vibration of the handle bars of the bicycle).

### Congestion Detection

Continuing with the example above, the motion data from the 9-axis inertial sensor (or other suitable sensor) may be used to detect congestion on bicycle paths or routes.

FIG. 17 illustrates a flowchart for the process which congestion may be detected on bicycle paths or routes. At step 1702 the motion data is processed this may include processing the yaw-pitch roll, angular velocity, linear acceleration data. Then at step 1704 congestion is detected by identifying characteristics in the motion data which may correspond to congestion on a bicycle path or route. For example, if the bicycle is going below a certain threshold or has come to several unexpected stops this may indicate congestion. It is appreciated that the validity of congestion increases as the sample size increases and congestion may only be reported when a particular threshold of data points is obtained. Then the position information corresponding to latitude and longitude may be used to mark the location of the congestion on a bicycle path or route (step 1706). This marked location may then be marked on a map which may be view on a computing device by cyclists.

Although in the examples above 9-axis inertial data was used to determine potholes and congestion, in other cases other suitable motion data could be used to make a similar determination in accordance with the invention.

### Route Suggestion, Parking Safety Score & Live Traffic Maps

The server 108 may provide the bicycles 102 with route suggestion based of a safety score that is calculated by ranking and analyzing data obtained by the plurality of bicycles 102. For example, congestion, road surface conditions, elevation, inclination, accident frequency, number of left and right turns, speed limit or any other suitable information may be processed by the server 108 to determine route suggestions.

In some cases, server 108 may provide the bicycles 102 with a parking safety score that is calculated by the sever 108 possibly based on reported latitude and longitude coordinates and the time of reported incident of stolen bicycles. This calculated parking safety score may be mapped to provide safety rankings for cyclists desiring to lock their bicycles.

The server 108 may provide a live traffic map that generating a live traffic map of the bicycles 102 from the position information received at the server 108.

### Automatic Gear Shifting

In another aspect of this disclosure, the electronic device 300ᵢ may be used to automatically control (e.g., shift or change) the gears of a bicycle and/or a continuously variable transmission, without mechanical adjustment of the gears by the cyclist or, alternatively, in complement thereof.

FIG. 22 shows a block diagram of the electronic device 300ᵢ shown in FIG. 2A, an actuator 2202 and a shifting mechanism 2204 in accordance with a specific implementation. As will likely become more readily apparent to the reader later on, the electronic device 300ᵢ is connected to the actuator 2202 to send control signals to the actuator 2202, such that the actuator 2202 then causes the shifting mechanism 2204 to adjust the gear ratio of the bicycle 102ᵢ. Also, as will be apparent herein, the adjustment of the gear ratio of the bicycle 102ᵢ may take place automatically based on bicycle inertia data, riding pattern data and/or user data, without direct control by the cyclist of the bicycle 102ᵢ.

### Bicycle Drivetrain

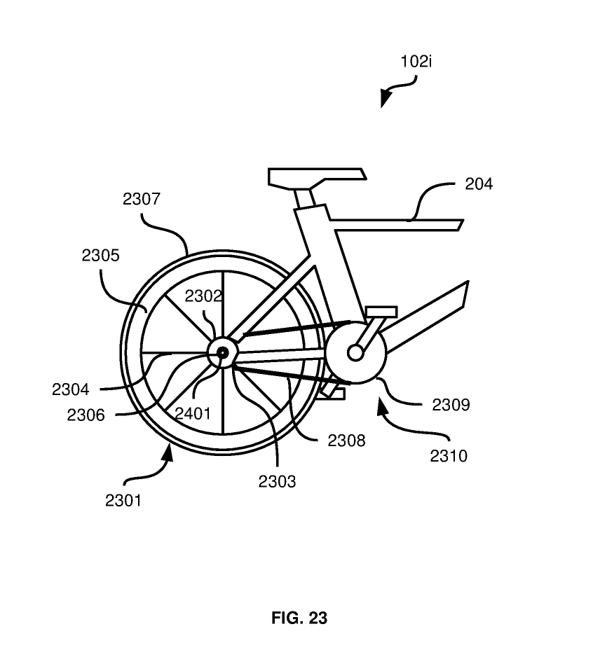

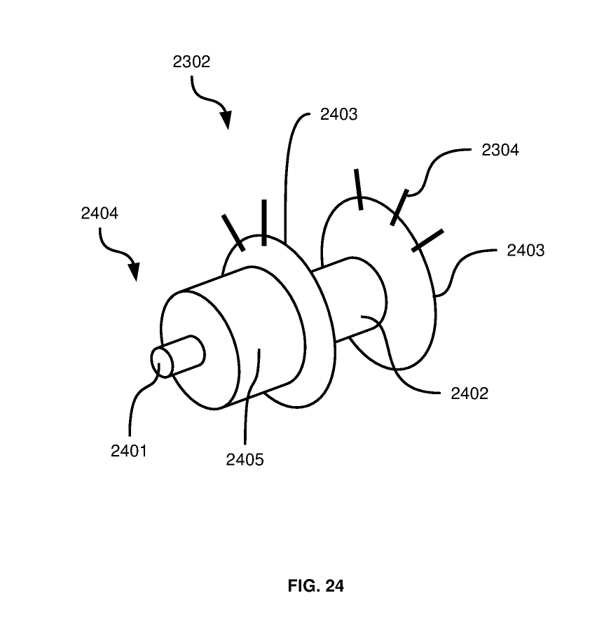

FIG. 23 shows a rear wheel 2301, a bicycle drivetrain 2310 and a part of the frame 204 of the bicycles 102ᵢ shown in FIG. 2A equipped with an electronic device in accordance with a specific implementation. The rear wheel 2301 fits into the frame 204 via a dropout 2303 and may be coupled to the frame 204. The rear wheel 2301 includes a hub 2302 located in the center part of the wheel 2301. FIG. 24 shows the hub 2302 shown in FIG. 23 in accordance with a specific implementation. The hub 2302 includes an axle 2401, bearings (not illustrated) and a hub shell 2402. Considering both FIGS. 23 and 24, the axle 2401 is used to couple the wheel 2301 to the dropout 2303 of the frame 204. The axle 2401 may be coupled to the dropout 2303 of the frame 204 by an attachment device 2306, which may be a quick release, nut, bolt, thru axle, female axle, or any other suitable device. The bearings allow the hub shell 2402 (and the rest of the wheel part) to rotate freely about the axle 2401. The hub shell 2402 is the part of the hub to which the spokes 2304 or disc structure attaches. In this example, the hub shell 2402 has two metal flanges 2403 to which spokes 2304 are attached. More specifically, each flange 2403 has holes or slots to which spokes are affixed. The rear wheel 2301 also includes a rim 2305 which may be made of metal, carbon fiber, or any other suitable material. In this example, the rear wheel 2301 includes a tire 2307 and a tire tube (not illustrated). In other cases, the rear wheel 2301 may be used with a tubeless tire.

The hub 2302 includes a gear portion 2404. The hub 2302 and gear portion 2404 may be implemented as a Freehub™ including a ratcheting mechanism as part of the hub 2302 and a single sprocket or a cassette containing a set of sprockets (e.g., a cogset or cluster), a freewheel including a ratcheting mechanism separate from the hub 2302 and a single sprocket or a set of sprockets, a track sprocket (e.g., a set of treads on the hub shell 2402 for receiving the sprocket), a flip-flop hub (e.g., both sides of the hub 2302 are threaded, and may be used with a single speed freewheel or a track sprocket, such as a fixed cogs), an internal geared hub, a continuously variable transmission and/or any other suitable mechanism.

In the example illustrated, the gear portion 2404 is implemented as an internal geared hub 2405. The internal geared hub 2405 is a mechanism with multiple gear-ratios that are enclosed inside the shell 2402 of the hub 2302. Internal geared hubs are known to the person of skill in the art and as such are not discussed in detail in this document. The internal geared hub 2405 may be implemented as a three (3) speed to fourteen (14) speeds, or any other suitable speed lower than three (3) or higher than fourteen (14), or as a continuously variable transmission hub.

In a specific and non-limiting example, the internal geared hub 2405 has three gears, a first gear, a second gear and a third gear. In this specific and non-limiting example, the internal geared hub 2405 is implemented with planetary or epicyclic gears. The gears are sealed within the shell 2402 of the hub 2405. By way of a non-limiting example, the first gear may be a low gear, in which a sprocket drives an annulus and a planet carrier drives a hub, giving a gear reduction. The second gear may be a middle gear, in which a sprocket drives the hub directly. The third gear may be a high gear, in which the sprocket drives the planet carrier and the annulus drives the hub, resulting in a gear increase. It is appreciated that the number of gears may be any suitable number and may be more or less than three in other embodiments.

A shifting mechanism 2204 is provided to shift or change between the different gears to select a gear ratio. The shifting mechanism typically depends on the type of hub and/or gears used and any suitable shifting mechanism 2204 may be used.

A belt (e.g. a carbon fiber-based belt) or chain 2308 is attached to a crankset or chainset 2309, such that reciprocating motion of the cyclist's legs is converted into rotational motion used to drive the belt or chain 2308. The belt or chain 2308 is also attached to the hub 2302 such that when the belt or chain 2308 is driven the rear wheel 2301 turns. Depending on the gear that bicycle is in (e.g., gear ratio) and the cadence (e.g., the rate at which the cyclist pedals), this determines the rate at which the wheel 2301 turns.

In some embodiments, a continuously variable transmission may be used as the internal geared hub 2405. The continuously variable transmission may also be known as a single speed or gearless transmission. The continuously variable transmission may be implemented using NuVinci™ continuously variable transmission available from Fallbrook Technologies. The continuously variable transmission is a transmission that may possible change seamlessly though an infinite number of effective gear ratios between a maximum and minimum value.

In some embodiments, such as where a sprocket, a set of sprockets, a cogset or cluster is use, a derailleur mechanism may be used as the shifting mechanism with a chain driven transmission. While in other cases, where a belt driven transmission is used, an internal geared hub may be used. It is appreciated that a belt driven bicycle is a chainless bicycle that uses a toothed synchronous belt 2308 to transmit power from the pedals to the wheel.

Bicycle wheels, hubs, gears, internal geared hub, shifting mechanism, belts, chains, crankset, chainset, continuously variable transmission and various other parts of the bicycle drivetrain are known in the art and are commercially available from many manufactures. The example bicycle wheels, hubs, gears, internal geared hub, shifting mechanism, belts, chains, crankset, chainset continuously variable transmission and various other parts of the bicycle drivetrain are for illustration purposes and any other suitable bicycle wheels, hubs, gears, internal geared hub, shifting mechanism, belts, chains, crankset, chainset continuously variable transmission and various other parts of the bicycle drivetrain may be used in accordance with this aspect of the disclosure.

### Gear Control

Referring back to FIG. 22, the electronic device 300ᵢ is connected to the actuator 2202 to send control signals to the actuator 2202, such that the actuator 2202 then causes the shifting mechanism 2204 to adjust the gear ratio of the bicycle 102ᵢ. The gear ratio as referred to herein is the ratio of the number of teeth on chainring 2309 to the number of teeth on the drive gear of gear portion 2404, modified by the internal gear ratio of an internal hub when applicable. In general, a higher gear ratio indicates that the rear wheel of the bicycle will undergo a larger number of revolutions for each revolution of chainring 2309, and a lower gear ratio indicates that the rear wheel of the bicycle will undergo a smaller number of revolutions for each revolution of chainring 2309. More specifically, in this embodiment, the input/output circuitry 310 of the electronic device 300ᵢ is connected to the actuator 2202. Electronic device 300ᵢ via the input/output circuitry 310 can send control signals to the actuator 2202, which can then adjust the gear of the gear portion 2404 of the hub 2302 or control the continuously variable transmission system of the bicycle 102ᵢ.

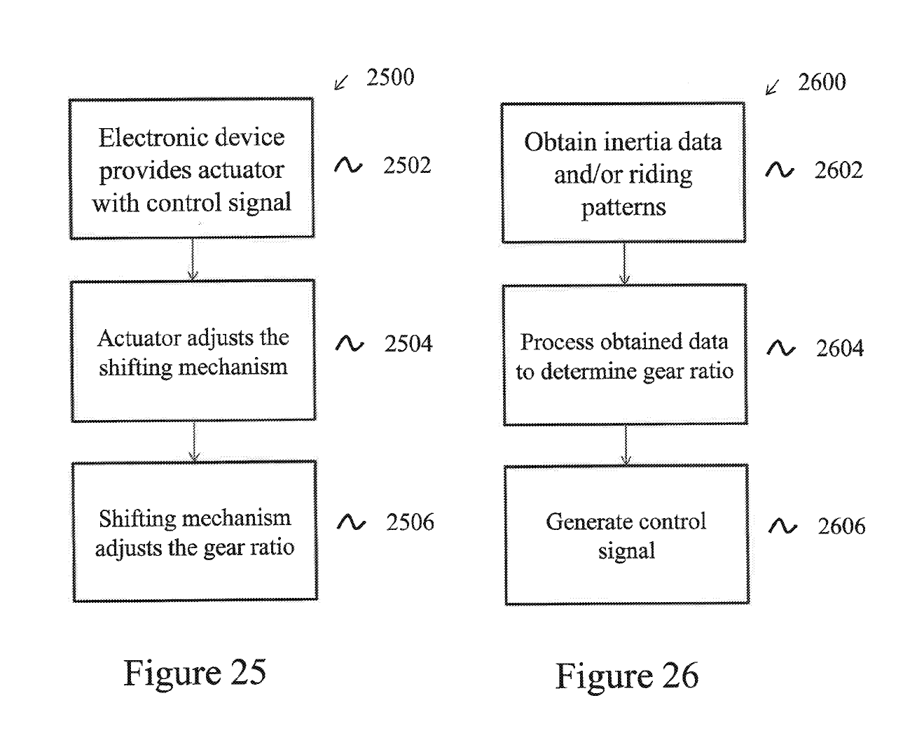

FIG. 25 illustrates a flowchart of a process 2500 for adjusting the gear ratio of the bicycle 102ᵢ. At step 2502 the electronic device 300ᵢ determines a control signal to send to the actuator 2202. The control signal may depend on the type of actuator 2202 used and the gear portion 2404 used. At step 2504, the actuator 2202 in response to the control signal from the electronic device 300ᵢ, then mechanically adjusts the shifting mechanism 2204. At step 2506, the mechanical adjustment of shifting mechanism causes the mechanical adjustment of the gears of gear portion 2404 of the hub 2302 and a change in the gear ratio of the bicycle 102ᵢ.

Continuing with the specific and non-limiting example of the internal geared hub 2405 having three gears, the control signal sent by the electronic device 300ᵢ to the actuator 2202 may be a control signal indicating the specific gear to put the internal geared hub 2405 in. For instance, the electronic device 300ᵢ may send a first control signal to indicate to the actuator 2202 to put the bicycle 102ᵢ into the first gear, a second control signal to indicate to the actuator 2202 to put the bicycle 102ᵢ into the second gear and a third control signal to indicate to the actuator 2202 to put the bicycle 102ᵢ into the third gear. Although in this example three control signals are used as there are three gears, it other embodiments the number of control signals may be more or less than three, and any suitable number of control signals may be used (e.g., the number of control signals may correspond to the number of gears in the internal geared hub 2405). In other cases, the control signal sent by the electronic device 300ᵢ to the actuator 2202 may be a control signal indicating an increment or decrement in a gear in the internal geared hub 2405.

In the cases where the internal geared hub 2405 is a continuously variable transmission is used, the control signal sent by the electronic device 300ᵢ to the actuator 2202 may be a control signal indicating an increment or decrement of the effective gear ratio and an amount of increment or decrement of the effective gear ratio.

In the cases where a derailleur mechanism is used as the shifting mechanism 2204, the control signal to the actuator 2202 may be a control signal that indicates an increment of decrement to the current sprocket of the cogset or cluster that the chain 2308 is in or may be a control signal that indicates the specific sprocket of the cogset or cluster to put the chain 2308 in.

### Gear Adjustment

The adjustment of the gear ratio of the bicycle 102ᵢ may take place automatically based on bicycle inertia data, riding pattern data and/or user data without direct mechanical control by the cyclist of the bicycle 102ᵢ.

### Bicycle Inertia Data

In some embodiments, the sensors 308 obtain information which is processed by the electronic device 300ᵢ to then determine the gear ratio to put the bicycle 102ᵢ in or an increment or decrement of the gear ratio and the amount of the increment or decrement. More specifically, the sensors 308 may obtain bicycle inertia data which can be processed by the processor 302 of the electronic device 300ᵢ to determine a gear ratio of the gear portion 2404 (e.g., the internal geared hub 2405) or an increment or decrement of the gear ratio and the amount of the increment or decrement. Based on the processing by the processor 302 the electronic device 300ᵢ may send a control signal to instruct the actuator 2202 to either increase or decrease the gear or gear ratio and the amount of the increase or decrease, as discussed elsewhere in this document.

The control signal determined by the processor 302 may be based off of one or more of the following data parameters, referred to above as inertia data: elevation data, orientation in space data (e.g. inclination), speed data, linear acceleration data, cadence, position (e.g., longitude and latitude and/or elevation) or any suitable data parameter. For instance, elevation data may be obtained through the accelerometer, gyroscope, barometer and/or magnetometer; orientation in space data may be obtained from the gyroscope, accelerometer and/or magnetometer; speed data may be obtained from the speedometer; linear acceleration data may be obtained from the accelerometer and altitude may be obtained from the barometer.

In the cases where the electronic device 300ᵢ is connected to the data network 106 and the Internet, the data parameters may also include weather data, such as wind speeds and temperatures or any other suitable weather data. The weather data may be obtained from public weather servers (e.g., Weather-Network). In some cases, the obtained weather data may be cross-referenced by the processor 302 with the data from the barometer.

### Riding Pattern Data

In some embodiments, riding pattern data may be obtained and processed by the electronic device 300ᵢ to then determine the gear ratio to put the bicycle 102ᵢ in or a direction of increment or decrement of the gear ratio and the amount of the increment or decrement. The riding pattern data may include: previous speed at various inclination/declination; speed after certain duration of riding (e.g., when the cyclist gets tired); preferred cadence and cruising speed, which may be calculated through statistical averages obtained from speed patterns. In other words, the riding pattern data can include a plurality of time-sequenced samples of the above-mentioned inertia data. The riding pattern data can also include, corresponding to each time-sequenced sample of inertia data, a current gear ratio. The riding pattern data can also include an indication of whether each sample gear ratio was controlled manually by the operator of bicycle 102 or automatically (e.g. by processor 302).

In the cases where the electronic device 300ᵢ is connected to the data network 106 and the Internet, the riding pattern data may include patterns based on traffic (congestion times/road closures) and patterns based on topography.

### User Data

In some embodiments, user data may be obtained and processed by the electronic device 300ᵢ, in combination with the inertia data and/or riding pattern data, to then determine the gear ratio to put the bicycle 102ᵢ in or an increment or decrement of the gear ratio and the amount of the increment or decrement. The user data may include age, gender, weight, height, or any other suitable information about the current user of the bicycle 102ᵢ.

It is appreciated that the adjustment of the gear ratio of the bicycle 102ᵢ may take place automatically based on bicycle inertia data, riding pattern data and user data, where the inertia data, riding pattern data and user data are available; however, where one or more of the inertia data, riding pattern data and user data is unavailable, the adjustment of the gear ratio of the bicycle 102ᵢ may take place automatically based on the available data.

### Standalone Adjustment of Gear Ratio

It is also appreciated that in this other aspect of this disclosure, the communication module 306 may be omitted in some implementations. It is also appreciated that in this other aspect of this disclosure, that the adjustment of the gear ratio of the bicycle 102ᵢ may take place automatically based on bicycle inertia data and/or riding pattern data without the electronic device 300ᵢ being connected directly or indirectly to the data network 106.

A specific and non-limiting example will now be presented of how the gear ratio of the bicycle 102ᵢ may be adjusted automatically based on bicycle inertia data and/or riding pattern data, without direct control by the cyclist of the bicycle 102ᵢ, when the electronic device 300ᵢ of the bicycle 102ᵢ is either is not connected to the data network 106 or where the electronic device 300ᵢ does not have a communication module 306.

In this example, initially the control signals for shifting the gear/gear ratio is based solely on real-time inertia data. Then as cyclist continues to use the bicycle 102ᵢ, riding pattern data may be recorded in the memory 304 of the electronic device 300ᵢ and then may be used in determining the signals for shifting the gear/gear ratio.

FIG. 26 illustrates a flowchart of a process 2600 for generating a control signal to adjust a gear ratio of a bicycle 102ᵢ. At step 2602 the electronic device 300ᵢ obtains inertia data, riding patterns and/or user data. Also, at step 2602, the electronic device 300ᵢ may also obtain the current gear/gear ratio of the bicycle 102ᵢ. In this example, as the riding pattern data and the user data is not available, at this step the inertia data is obtained. Then at step 2604, the processor 302 of the electronic device 300ᵢ processes the obtained data to determine the gear ratio or an increment or decrement of the gear ratio and the amount of the increment or decrement. At step 2604 this may be a change in the current gear ratio that is determined. In this example, as only the real-time inertia data is available, the processor 302 determines a desired gear ratio based solely on this data. Then at step 2606, a control signal is generated based on the determined desired gear ratio. In some cases, at step 2606, if it is determined that the desired gear ratio is different than the current gear ratio then a control signal is generated; however, if it is determined that the desired gear ratio is the same as the current gear ratio then a control signal is not generated. Then once the control signal is generated at step 2606, the process 2500 (discussed elsewhere in this document) may then be used to adjust the gear ratio.

By way of example, if the obtained inertia data at step 2602 indicates that orientation in space of the bicycle 102ᵢ suggests that the bicycle 102ᵢ is currently going up an incline, a reduction in speed and/or linear deceleration is occurring, then at step 2604 it may be determined that the bicycle 102ᵢ should be put into a lower gear (that is, a lower gear ratio).

By way of another example, if the obtained inertia data at step 2602 indicates that orientation in space of the bicycle 102ᵢ suggests that the bicycle 102ᵢ is currently going down a decline, an increase in speed and/or linear acceleration is occurring, then at step 2604 it may be determined that the bicycle 102ᵢ should be put into a higher gear (that is, a higher gear ratio).

After or during the process 2600, the electronic device 300ᵢ may also store in the memory 304 aspects of the inertia data to create riding pattern data. After a certain amount of inertia data is obtained the electronic device 300ᵢ may process this inertia data to create riding pattern data. Then as the process 2600 repeats, which may be at a set interval stored in the memory 304, the riding pattern data can then be taken into account in future iteration of the process 2600.

The interval at which the process 2600 repeats, may be any suitable time interval. In some cases the interval is every millisecond, several milliseconds, second, several seconds and possibly a minute or more.

By way of example, once riding pattern data is available and considering the process 2600, if the obtained inertia data at step 2602 indicates that orientation in space of the bicycle 102ᵢ suggests that the bicycle 102ᵢ is currently going down a declination and at step 2602 the obtained riding pattern data indicates the cyclists speed at previous declinations, then at step 2604 it may be determined that the bicycle 102ᵢ should be put into a different gear to adjust for the difference in current speed and previous declination speeds.

By way of example, once riding pattern data is available and considering the process 2600, if the obtained inertia data at step 2602 indicates that orientation in space of the bicycle 102ᵢ suggests that the bicycle 102ᵢ is currently going up an inclination and at step 2602 the obtained riding pattern data indicates the cyclists speed at previous inclinations, then at step 2604 it may be determined that the bicycle 102ᵢ should be put into a different gear to adjust for the difference in current speed and previous inclination speeds.

As a further example, a gear ratio (or an adjustment to the current gear ratio) may be selected by processor 302 based on inertia data by comparing the current cadence (e.g. revolutions per minute of chainring 2309) to a target cadence (e.g. 70 rpm). Based on the difference between the current cadence and the target cadence, processor 302 can select a new gear ratio. The difference between the new gear ratio selected and the current gear ratio can, for example, be proportional to the difference between the current cadence and the target cadence. Thus, if the current cadence is lower than the target cadence, a new gear ratio can be selected by processor 302 that is lower than the current gear ratio.

In some embodiments, the target cadence mentioned above can be derived (either by processor 302, or by server 108 and transmitted to processor 302) from the riding pattern data. For example, processor 302 can determine or receive (e.g. from server 108) an average cadence from the riding pattern data, and set that average cadence as the above-mentioned target. In further embodiments, a plurality of average cadences can be selected and set as a plurality of target cadences. For example, processor 302 can calculate or receive an average cadence associated with each of a plurality of inclinations (e.g. an average cadence for inclinations of zero to two percent, and a second average cadence for inclinations greater than two percent). The selection of gear ratios can then be performed by processor 302 by selecting one of the target cadences based on the current inclination, and comparing the current cadence to the selected target cadence.

It is appreciated that if the gear portion 2404 of the hub 2302 is implemented as an internal geared hub 2405 that is a continuously variable transmission (or another suitable device) that at steps 2604 and 2606 then a control signal may continuously (e.g., at a very frequent interval) be send to the actuator 2202. It is also appreciated that in this case the control signal may indicate the direction of change to the gear ratio and the amount of change to the gear ratio.

### User Profile Based Adjustment of Gear Ratio

Different gear ratios are appropriate for different people and styles of cycling and as such it may be desirable for the electronic device 300ᵢ to have information about the user when making a determination of the gear ratio of the bicycle 102ᵢ.

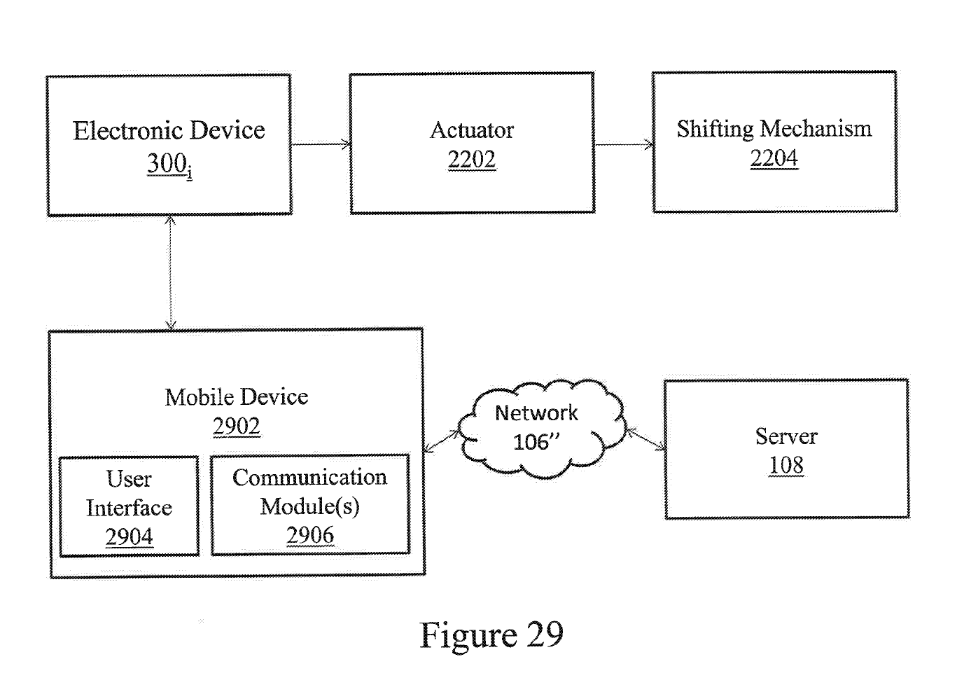

FIG. 29 shows a block diagram of the electronic device 300ᵢ, the actuator 2202, the shifting mechanism 2204, a mobile device 2902 and the server 108. One way for the electronic device 300ᵢ to have information about the user is for the user of the bicycle 102ᵢ to login via an application on a mobile device 2902 (e.g., cellphone, tablet, or any other suitable device) so that the electronic device 300ᵢ may be provided with user data. As discussed elsewhere in this document, the user may first create a user account with the server 108. Once the user has a user account with the server 108, the user may login via the mobile device 2902 (or other suitable computing device) to provide user data (e.g., age, gender, weight, height and/or any other suitable data) to the server 108. The user data may be stored in association with the user's account in database 408 of the computer readable memory 404 of the server 108.

In some embodiments, therefore, processor 302 can implement variable shifting behaviour based on which mobile device (e.g. device 2902) is currently connected to electronic device 300. Different mobile devices are authorized to obtain riding pattern data from server 108 for different users, and thus electronic device 300 can set different cadence targets (as discussed earlier) based on what riding pattern data is available via mobile device 2902.

The mobile device 2902 may communicate with the electronic device 300ᵢ via a communication module 2906 in the mobile device 2902 and the communication module 306 in electronic device 300ᵢ. The communication module 2906 may include one or more modules for communicating with third party device using a Wi-Fi protocol (e.g., IEEE 802.11 protocol), Bluetooth protocol, cellular network protocol(s) (e.g., GSM, AMPS, GPRS, CDMA, EV-DO, EDGE 3GSM, DECT, IS-136/TDMA, iDen, LTE or any other suitable cellular protocol), ZigBee protocol (e.g., IEEE 802.15 protocol), protocols operating in the 900 MHz, 2.4 GHz, 5.6 GHz ranges, or any other suitable protocol or any combination thereof. The communication module 2906 in the mobile device 2902 and the communication module may be any suitable communication modules. In some implementations, the communication module 2904 in the mobile device 2902 and the communication module 306 in electronic device 300ᵢ are Bluetooth communication modules. The communication module 2906 in the mobile device 2902 may communicate with the server 108 over a cellular and/or data network 106″.

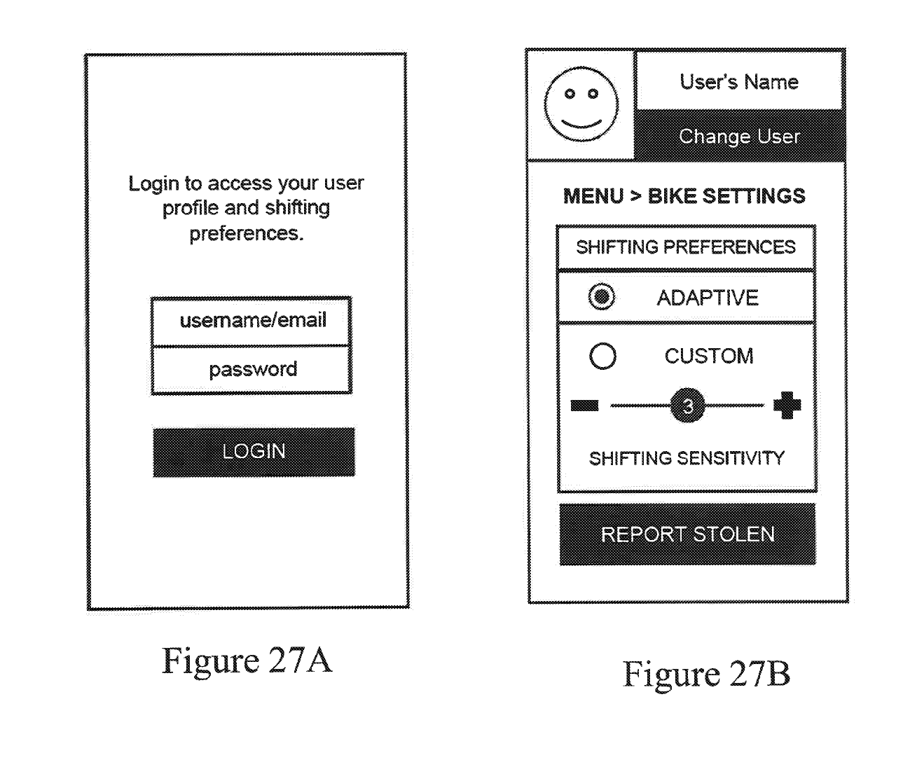

FIG. 27A illustrates an example screenshot of a user interface 2904 of the mobile device 2902 for which a user may login to the server 108. After the user provides a username or email and a password, the user may then connect to the server 108 with the mobile device 2904. The user interface 2904 may also provide an interface for pairing the mobile device 2902 with the bicycle 102ᵢ; for example, for the electronic device 300ᵢ to communicate with the mobile device 2904.

A specific and non-limiting example will now be presented of how the gear ratio of the bicycle 102ᵢ may be adjusted automatically based on bicycle inertia data from the sensors 308 and riding pattern data and/or user data (if available), without direct mechanical control of the gears by the cyclist of the bicycle 102ᵢ. The user data may be obtained by the mobile device 2902 from the server 108 via the network 106″ and then provided to the electronic device 300ᵢ.

In this example, initially the control signals for shifting the gear/gear ratio is based on real-time inertia data from the sensors 308 and the user data obtained from the server 108. Then as cyclist continues to use the bicycle 102ᵢ, riding pattern data may be transmitted from the electronic device 300ᵢ via the mobile device 2902 over the network 106 to the server 108.

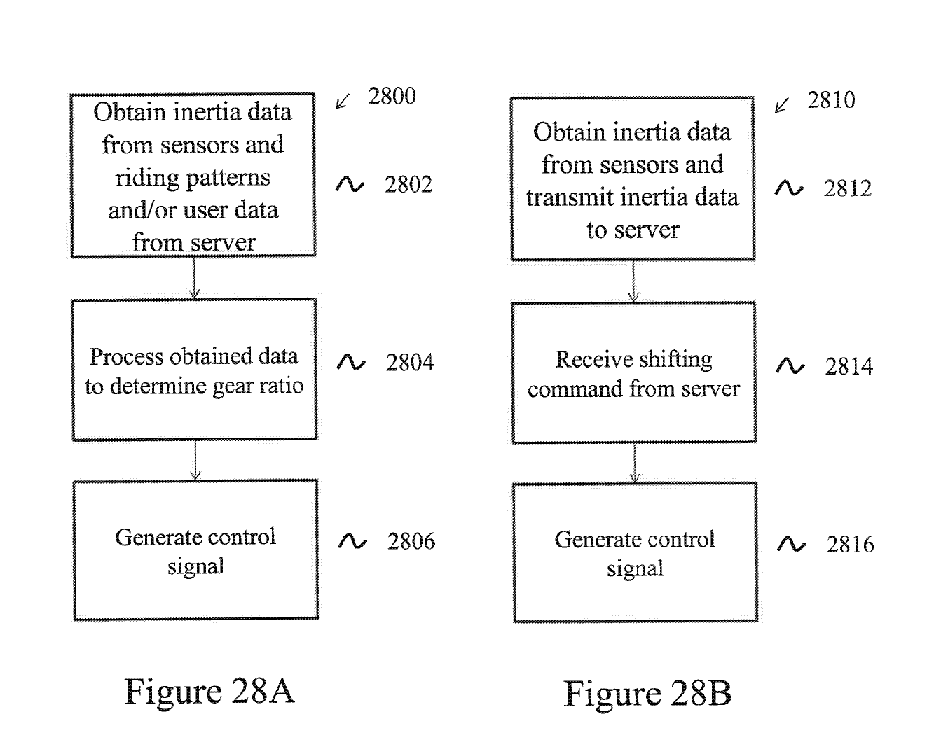

FIG. 28A illustrates a flowchart of a process 2800 for generating a control signal to adjust a gear ratio of a bicycle 102ᵢ. At step 2802 the electronic device 300ᵢ obtains inertia data from the sensors 308 and riding patterns and/or user data from the server 108. Also, at step 2802, the electronic device 300ᵢ may also obtain the current gear/gear ratio of the bicycle 102ᵢ. In this example, as the riding pattern data is not available, at this step the inertia data and the user data are obtained. Then at step 2804, the processor 302 of the electronic device 300ᵢ processes the obtained data to determine the gear ratio or an increment or decrement of the gear ratio and the amount of the increment or decrement. At step 2804 this may be a change in the current gear ratio that is determined. In this example, as only the real-time inertia data and the user data is available; the processor 302 determines a desired gear ratio based solely on this data. Then at step 2806, a control signal is generated based on the determined desired gear ratio or an increment or decrement of the gear ratio and the amount of the increment or decrement. In some cases, at step 2806, if it is determined that the desired gear ratio is different than the current gear ratio then a control signal is generated; however, if it is determined that the desired gear ratio is the same as the current gear ratio then a control signal is not generated. Then once the control signal is generated at step 2806, the process 2500 (discussed elsewhere in this document) may then be used to adjust the gear ratio.

By way of example, if the obtained inertia data at step 2802 indicates that orientation in space of the bicycle 102ᵢ suggests that the bicycle 102ᵢ is currently going up an inclination, a reduction in speed and/or linear deceleration is occurring, then at step 2604 it may be determined that the bicycle 102ᵢ should be put into a lower gear.

By way of another example, if the obtained inertia data at step 2802 indicates that orientation in space of the bicycle 102ᵢ suggests that the bicycle 102ᵢ is currently going down a declination, an increase in speed and/or linear acceleration is occurring, then at step 2604 it may be determined that the bicycle 102ᵢ should be put into a higher gear.

In these examples, the amount of the adjustment to the change in the gear may be determined based on the orientation in space of the bicycle 102ᵢ, the speed and/or linear acceleration and the user data. For example, a user with a tall height and/or high weight may be given a different gear ratio than a user with a short height and/or low weight for the same orientation in space of the bicycle 102ᵢ, same speed and/or same linear acceleration.

After or during the process 2800, the electronic device 300ᵢ may transmit via the mobile device 2902 over the network 106 to the server 108 some or all of the inertia data to create riding pattern data associated with the user in the user's account. Then as the process 2800 repeats, which may be at a set interval stored in the memory 304, the riding pattern data can then be taken into account in future iteration of the process 2800.

The interval at which the process 2800 repeats, may be any suitable time interval. In some cases the interval is every millisecond, several milliseconds, second, several seconds and possibly a minute or more.

Once the server 108 has logged a certain number of data points of inertial data, the server 108 may process the inertial data to create the above-mentioned riding pattern data for the specific user. The riding pattern data for the user can then be stored in the computer readable memory 404 of the server 108. The riding pattern data for the user can then be transmitted from the server 108 to the mobile device 2902 and transmitted to the electronic device 300ᵢ such that riding pattern data can be stored in the computer readable memory 304 and then accessed by electronic device 300ᵢ in determining the gear ratio or determining an increment or decrement of the gear ratio and the amount of the increment or decrement

By way of example, once riding pattern data is available and considering the process 2800, if the obtained inertia data at step 2802 indicates that orientation in space of the bicycle 102ᵢ suggests that the bicycle 102ᵢ is currently going down a declination and at step 2802 the obtained riding pattern data indicates the cyclists speed at previous declinations, then at step 2604 it may be determined that the bicycle 102ᵢ should be put into a different gear to adjust for the difference in current speed and previous declination speeds.

By way of example, once riding pattern data is available and considering the process 2800, if the obtained inertia data at step 2802 indicates that orientation in space of the bicycle 102ᵢ suggests that the bicycle 102ᵢ is currently going up an inclination and at step 2802 the obtained riding pattern data indicates the cyclists speed at previous inclinations, then at step 2604 it may be determined that the bicycle 102ᵢ should be put into a different gear to adjust for the difference in current speed and previous inclination speeds.

It is appreciated that if the gear portion 2404 of the hub 2302 is implemented as an internal geared hub 2405 that is a continuously variable transmission (or another suitable device) that at steps 2804 and 2806, then a control signal may continuously (e.g., at a very frequent interval) be send to the actuator 2202.

### Server Based Shifting Commands

FIG. 28B illustrates a flowchart of a process 2810 for generating the control signal to adjust the gear ratio of the bicycle 102ᵢ. At step 2812 the electronic device 300ᵢ obtains the inertia data from the sensors 308 and then sends the inertia data to the server 108 via the mobile device 2902 and the network 106″. Then this sent data (e.g., inertia data) is received by the server 108. The server 108 then processes the received data (e.g., inertia data) to determine a shifting command (e.g., a gear ratio, an increment or decrement in a gear, and/or the amount of the increment or decrement of the gear ratio). Then the server 108 transmits back to electronic device 300ᵢ the shifting command (e.g., a gear ratio, an increment or decrement in a gear, and/or the amount of the increment or decrement of the gear ratio). At step 2814, the shifting command (e.g., a gear ratio, an increment or decrement in a gear, and/or the amount of the increment or decrement of the gear ratio) is the received by the electronic device 300ᵢ via the mobile device 2902. At step 2816, the electronic device 300ᵢ generates the control signal based on the shifting command received from the server 108.

It is appreciated that the server may also take in to account the user data and/or the riding pattern of the user when determining the shifting command.

### Shifting Preferences

FIG. 27B illustrates an example screenshot of a user interface of a mobile device for which a user may provide shifting preferences, once the user has logged in via the screenshot shown in FIG. 27A. The user interface is the conditioned with the user's existing settings for shifting preferences stored in memory 404 the server 108. The user may then change the shifting preferences. For example, by default the user's shifting preferences may be set to “adaptive”. The “adaptive” shifting setting indicates to the user that the software on the server 108 processes the provided inertia data to build riding pattern data, and enables electronic device 300 to shift automatically to suit the user's needs. The user may be able to select a “custom” (i.e. manual) shifting preference in which the user can control shifting manually (e.g. via a shifter mechanism on bicycle 102ᵢ discussed in greater detail below). It is appreciated that the “custom” shifting preference does not stop the software on the server 108 from learning the cyclist's style and habits (that is, inertia data can still be transmitted to server 108 by electronic device 300).

It is appreciated that adaptive shifting may provide for the actuator 2002 on the bicycle hub 2302, under the control of electronic device 300ᵢ to automatically adjust gear ratios without a mechanical adjustment by the rider of the bicycle 102ᵢ. The adaptive adjustment or smart-shifting may be based on sensor data (e.g., inertia data), user profile information, and/or riding pattern data, as discussed above.

It is also appreciated that the riding pattern data may be analyzed by the server 108 and then transmitted to the electronic device 300ᵢ via the mobile device 2902. Then, the electronic device 300ᵢ may automatically control actuator 2202 based on the riding pattern data to take into account the user's shifting preference, as discussed earlier.

It is also appreciated that the sensors 308 may also send data (e.g., inertia data) to the server 108 via the mobile device 2902 and the network 106″ such that sent data (e.g., inertia data) is processed by the server 108. Then the server 108 may transmit back to electronic device 300ᵢ the shifting command (e.g., the gear ratio that the bicycle 102ᵢ should be put in) and the electronic device 300ᵢ generates the control signal based on the shifting command received from the server 108 and may take into account the user's shifting preference.

### Handlebar Based Shifting

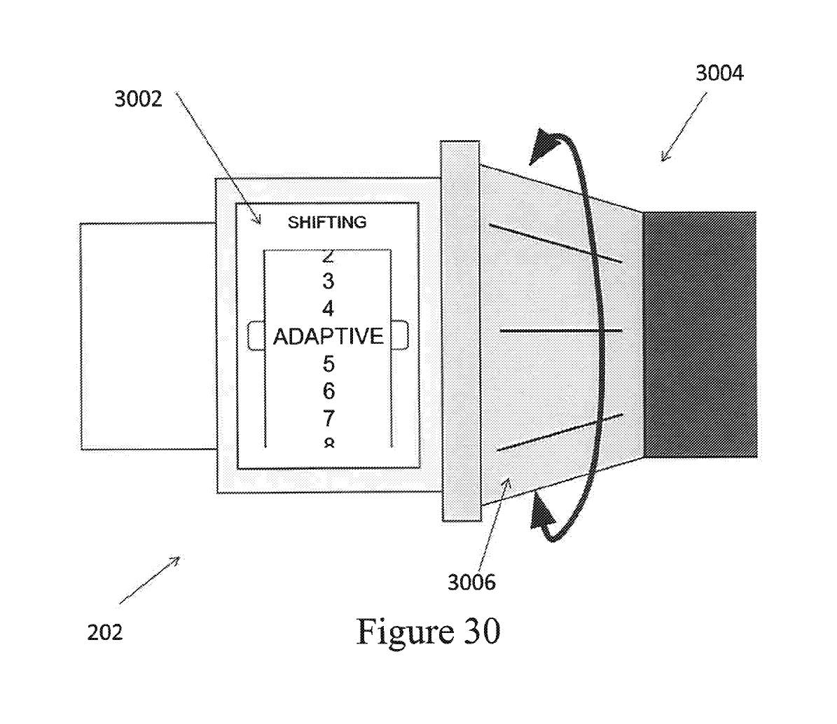

FIG. 30 illustrates a single grip 3004 on the right side of the handle bar 202 of the bicycle 102ᵢ. The grip 3004 includes a twist shifter 3006 and a shifting display 3002 (it is contemplated that shifter 3006 and display 3002 can also be disposed on the left side of handlebar 202). The shifting display 3002 may be any suitable analog or digital display, or any combination thereof, or any other suitable device.

The interface 3002 may displays a finite selection of gear ratios, manually selectable by operation of twist shifter 3006. For continuously variable transmissions, display 3002 need not present a finite selection of gear ratios. Instead, display 3002 can present a continuous scale encompassing a large or infinite number of selectable gear ratios. The interface 3002 may also have an “Adaptive” option (also selectable by twist shifter 3006) that may link to the user's riding patterns which may be obtained from their user profile and the bicycles real-time inertia data as mentioned elsewhere in this document. In other words, the “adaptive” option is selectable to transition from manual shifting to automatic shifting according to the processes discussed above.

It is appreciated that such a grip 3004 may provide a secondary user-interface for the user as an alternative to the user using a mobile device 2902. In other words, such a configuration may provide an alternative to using a mobile interfacing while riding a bicycle.

In the example illustrated, the display 3002 is a digital display and the shifter 3006 when rotated causes a digital signal to be sent to the electronic device 300ᵢ to indicate a desired gear ratio. In other cases, the movement of the shifter 3006 commands the digital interface up or down. Yet in other case the shifter 3006 may be omitted, if the display 3002 is a touch-screen or other suitable display.

### Guest Mode

In some cases, in may be desirable for the user to not have user account associated with the bicycle, when the bicycle 102ᵢ is in use. For example, if the owner of the bicycle 102ᵢ is borrowed to a third-party, the owner of the bicycle 102ᵢ may not want the third-parties' user data to influence owner's future usage of the bicycle 102ᵢ and vice versa.

Instead of the user login into the user profile, setting the user's shifting preference, and the server 108 obtain the usage data (e.g., inertia data), a third-party may use the bicycle 102ᵢ without the server 108 obtaining, storing and processing the usage data (e.g., inertia data) to create or update the riding pattern data for the user. In other words, the default setting of the bicycle 102ᵢ when the bicycle is not connected to the mobile device 2902 is to not obtain, storing and processing the usage data (e.g., inertia data) to create or update the riding pattern data for the user.

In other cases, the user may login into the user profile and set the bicycle to “guest mode” such that no usage data (e.g., inertia data) is obtained, stored and process.

### Location Based Shifting

In some cases, the GPS sensor 308 of the electronic device 300ᵢ may obtain coordinate or location information (e.g., longitude and latitude) which may then be communicated to the server 108. The server 108 may then provide gear information based on the current coordinate information. For example, the for a first specific location the computer readable memory 404 of the server 108 may store an indication that the bicycle should be put into the first gear, while for a second specific location the computer readable memory 404 of the server 108 may store an indication that the bicycle should be put into the second gear.

In other cases, the electronic device 300ᵢ stores a mapping in the database in the computer readable memory 304 of the electronic device 300ᵢ of the location information (e.g., longitude and latitude) with a gear setting. In this case, the GPS of the electronic device 300ᵢ provides location information (e.g., longitude and latitude) which is then looked-up in the database of the electronic device 300ᵢ to obtain the information regarding which gear to put the bicycle 102ᵢ in. Then, the electronic device 300ᵢ may send a control signal to the actuation device to indicate to the actuation device which gear to put the bicycle 102ᵢ in.

### Compartmentalizing the Electronic Device in the Hub

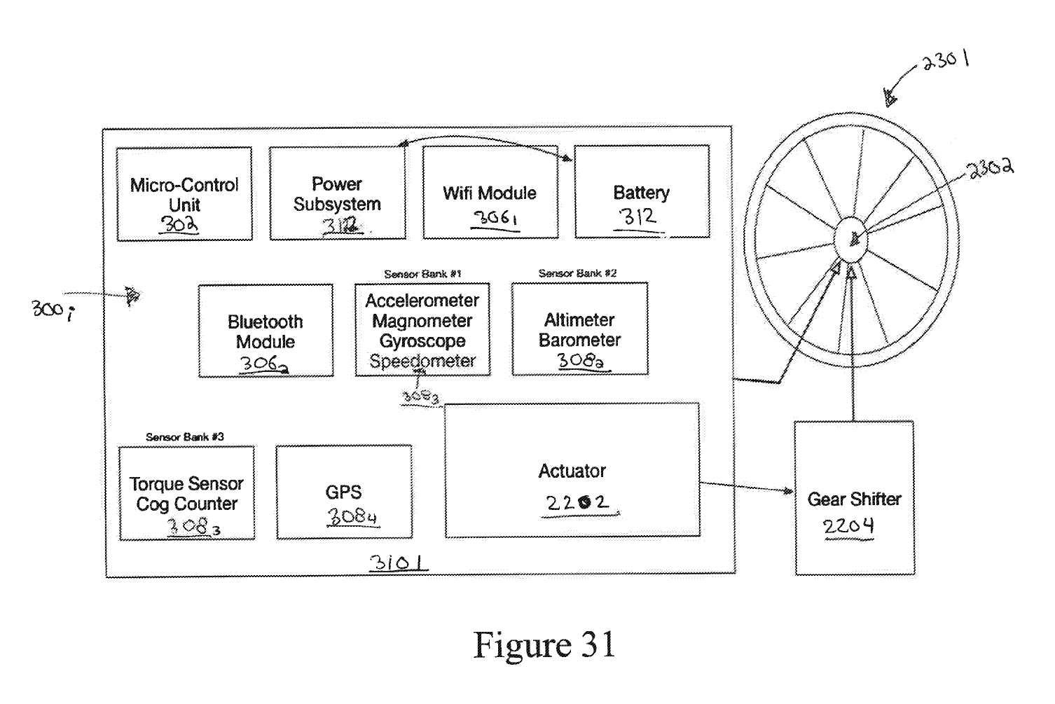

FIG. 31 illustrates a specific and non-limiting example of a shifting device 3101 comprising the electronic device 300ᵢ and the actuator 2202. In this example, the shifting device 3101 may be compartmentalization around an exterior lip of the hub 2302. In this example, shifting device 3101 comprising: a processor 302; a power source 312 connected to a power subsystem 3122; a Wi-Fi module 306₁; a Bluetooth module 306₂; a first sensor bank 308₁ including one or more of an accelerometer, a magnometer, a gyroscope and a speedometer; a second sensor bank 308₂ including one or more of an altimeter and barometer; a third sensor bank 308₃ including one or more of an torque sensor and a cog counter; a GPS 308₄ and a actuator 2202.

The shifting device 3101 can be placed in similar positions throughout the bicycle much like electronic device 300ᵢ. In some cases, the shifting device 3101 is compartmentalized within in the hub 2302 of the bicycle 102ᵢ. In other cases, the shifting device 3101 is not compartmentalized within the hub 2302 but is located within another part of the bicycle 102ᵢ and is connected with the hub 2302 via one or more wires.

It is appreciated that in other embodiments, the shifting device 3101 is compartmentalized within other parts of the bicycle 102ᵢ. For example, shifting device 3101 may be placed in the down-tube, steer tube and the rear-dropout. It is appreciated that by placing the smart-hub in the rear-dropout may facilitate a parallel connection with the actuator 2202 with minimal wire-routing.

If the bicycle is already equipped with a dynamo, usually placed at on the front wheel hub, then the battery 312 may be charged through it. In other cases a charging outlet located on the shifting device 3101 may allow for the shifting device 3101 to be connected either through a micro-usb or any other power-transferring medium to recharge the battery 312 compartmentalized within the shifting device 3101.

### Theft Deterrence

A theft deterrence feature is provided such that when the bicycle 102ᵢ receives an indication that it is stolen (as discussed elsewhere in this document), the electronic device 300ᵢ may be instructed directly or indirectly via the server 108 or automatically to place the bicycle 102ᵢ in to the lowest and/or highest available gear ratio. In other words, the actuator 2202 may be disabled possibly causing the bicycle to be difficult to use.

Although in the examples above bicycles are used, the invention is not limited to bicycles and other vehicles such as motorcycles, scooters, ATVs, snowmobiles, golf carts or any other suitable vehicle could be used.

There person of skill in the art would understand that there are many different ways to store data in tables and databases and that the invention is not limited to the examples given.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Although various embodiments and examples have been presented, this was for the purpose of describing, but not limiting, the invention. Various modifications and enhancements will become apparent to those of ordinary skill in the art and are within the scope of the invention, which is defined by the appended claims.

1. An electronic device for a network-enabled bicycle comprising:
a communication module;
a non-transitory computer readable storage medium; and
a processor configured to:
i. monitor operational parameters associated with the network-enabled bicycle and recording on the non-transitory computer readable storage medium data conveying information related to usage of the network-enabled bicycle;
ii. use the communication module to detect a presence of an other network-enabled bicycle in a communication range of the network-enabled bicycle;
iii. when the presence of the other network-enabled bicycle in the communication range of the network-enabled bicycle has been detected: use the communication module to establish a communication link with the other network-enabled bicycle and perform an exchange of data with the other network-enabled bicycle over the communication link, wherein during the exchange of data operational parameters associated with the other network-enabled bicycle are received and stored on the non-transitory computer readable storage medium.

2. An electronic device as defined in claim 1, wherein said processor is further configured to:
a. use the communication module to detect a presence of a wireless network access point in a communication range of the network-enabled bicycle, wherein the wireless network access point facilitates a connection to a public data network;
b. when the presence of the wireless network access point has been detected:
i. use the communication module to establish a communication link with the wireless network access point; and
ii. cause information stored on the non-transitory computer readable storage medium data to be transmitted to a remote computing device via the wireless network access point, wherein the remote computing device is in communication with the public data network, wherein the information transmitted to the remote computing device via the wireless network access point includes at least one of information related to usage of the network-enabled bicycle, and information related to usage of the other network-enabled bicycle.

3. An electronic device as defined in claim 1 or claim 2, wherein the monitored operational parameters associated with the network-enabled bicycle include one or more metrics selected from the group consisting of bicycle speed, bicycle inclination, distance, elevation, position information and duration of displacement.

4. An electronic device as defined in any one of claims 1 to 3, wherein using the communication module to establish the communication link with the wireless network access point includes performing a process to authenticate the network-enabled bicycle with the wireless network access point.

5. An electronic device as defined in claim 1, wherein said processor is further configured to:
a. use the communication module to detect a presence of a portable communication device in a communication range of the network-enabled bicycle, the portable communication device being connectable with a wireless network access point, wherein the wireless network access point facilitates a connection to a public data network;
b. when the presence of the portable communication device has been detected:
i. use the communication module to establish a communication link with the portable communication device; and
ii. cause information stored on the non-transitory computer readable storage medium data to be transmitted to a remote computing device via the portable communication device and the wireless network access point, wherein the remote computing device is in communication with the public data network, wherein the information transmitted to the remote computing device via the portable communication device and the wireless network access point includes at least one of information related to usage of the network-enabled bicycle, and information related to usage of the other network-enabled bicycle.

6. The electronic device of claim 2, wherein said establishing a communication link with the other network-enabled bicycle and said establishing a communication link with the wireless network access point creates a mesh network where the other network-enabled bicycle can communicate with the remote computing device via the electronic device.

7. A network-enabled bicycle comprising:
a. a bicycle frame; and
b. an electronic device as defined in any one of claims 1 to 6, wherein the electronic device is mounted to said bicycle frame.

8. The network-enabled bicycle of claim 7, wherein the electronic device is at least partially embedded within the bicycle frame.

9. A method for connecting a first network-enabled bicycle to a network, the network including a plurality of network-enabled bicycles, the plurality of network-enabled bicycles including at least a second network-enabled bicycle, said first network-enabled bicycle including an electronic device, said method comprising:
a. monitoring operational parameters associated with the first network-enabled bicycle and recording on a non-transitory computer readable storage medium of the electronic device data conveying information related to usage of the first network-enabled bicycle;
b. detecting a presence of the second network-enabled bicycle in a communication range of the first network-enabled bicycle;
c. when the presence of the second network-enabled bicycle in the communication range of the network-enabled bicycle has been detected:
i. establishing a communication link between the first network-enabled bicycle and the second network-enabled bicycle; and
ii. performing an exchange of data over the communication link, wherein during the exchange of data operational parameters associated with the second network-enabled bicycle are received and stored on the non-transitory computer readable storage medium of the electronic device;
d. detecting a presence of a wireless network access point in a communication range of the first network-enabled bicycle, wherein the wireless network access point facilitates a connection a public data network;
e. when the presence of the wireless network access point has been detected:
i. establishing a communication link between the first network-enabled bicycle and the wireless network access point; and
ii. causing information stored on the non-transitory computer readable storage medium data of the electronic device to be transmitted to a remote computing device via the wireless network access point, wherein the remote computing device is in communication with the public data network and wherein the information transmitted to the remote computing device via the wireless network access point includes at least one of information related to usage of the first network-enabled bicycle, and information related to usage of the second network-enabled bicycle.

10. A computer program product, tangibly stored on one or more tangible computer readable storage media, for providing an owner of a first network-enabled bicycle with theft recovery functionality in connection with the first network-enabled bicycle, the first network-enabled bicycle being one of a plurality of network-enabled bicycles, the program product comprising instructions that, when executed, cause a programmable system including at least one programmable processor to perform operations, the operations comprising:
a. receiving information conveying a theft report in connection with the first network-enabled bicycle;
b. receiving data corresponding to position information of one or more of the plurality of network-enabled bicycles;
c. processing the received position information to determine if recent position information corresponding to the first network-enabled bicycle has been received, the recent position information being associated to a time period subsequent to receipt of the information conveying the theft of the first network-enabled bicycle;
d. when it is determined that recent position information corresponding to the first network-enabled bicycle has been received:
i. generating an electronic notification message conveying the recent position information corresponding to the first network-enabled bicycle;
ii. transmitting the electronic notification message over a data network to a computer device associated with the first network-enabled bicycle to notify an operator of the computer device of the recent position information corresponding to the first network-enabled bicycle.

11. A computer program product as defined in claim 10, wherein receiving data corresponding to position information of one or more of the plurality of network-enabled bicycles is provided via the first network-enabled bicycle over a wireless communication link.

12. A computer program product as defined in claim 10, wherein receiving data corresponding to position information of one or more of the plurality of network-enabled bicycles is provided via a second network-enabled bicycle, where the second network-enabled bicycle obtained the specific recent position information associated with the first network-enabled bicycle from connecting to the first network-enabled bicycle and receiving the specific recent position information corresponding to the first network-enabled bicycle from the first network-enabled bicycle.

13. A computer program product as defined in claim 10, wherein the first network-enabled bicycle is associated with a first identifier; and wherein processing the received position information to determine if recent position information associated with the first network-enabled bicycle has been received includes determining if the position information includes information associated with the first identifier.

14. A computer program product as defined in claim 10, wherein receiving the information conveying a theft report of the network-enabled bicycle includes receiving motion or vibration data of the network-enabled bicycle.

15. A device for controlling a gear ratio of a bicycle, the device comprising:
a. an electronic device comprising control circuitry configured for:
i. receiving inertia data from one or more sensors positioned on the bicycle;
ii. processing the inertia data to determine an increment or a decrement of a gear ratio for the bicycle and the amount of the increment or the decrement of the gear ratio for the bicycle;
iii. generating a control signal indicating the increment or the decrement of a gear ratio for the bicycle and the amount of the of the increment or the decrement of the gear ratio for the bicycle;
b. an actuator in communication with said electronic device for receiving said control signal, said actuator being configured for adjusting the gear ratio of the bicycle at least in part based on results obtained by processing said control signal.

16. The device of claim 15, the electronic device further configured for:
i. obtaining riding pattern data from a remote computer server over a data network;
ii. processing the riding pattern data with the inertia data to determine the increment or a decrement of a gear ratio for the bicycle and the amount of the increment or the decrement of the gear ratio for the bicycle.

17. The device of claim 15, the electronic device further configured for:
a. generating data for controlling a display connected to the electronic device to present a user of the bicycle with selectable input options for specifying gear shifting preferences, the input options allowing the user of the bicycle to select through a user input device a specific gear shifting preference from a group including at least:
i. a first gear shifting preference associated with an adaptive mode for gear shifting;
ii. a plurality of further gear shifting preferences each associated with one of a plurality of gear ratios;
b. receiving a selection of one of the gear shifting preferences;
c. when the selected gear shifting preference corresponds to the adaptive mode for gear shifting, processing the intertia data and generating the control signal;
d. when the selected gear shifting preference corresponds to one of the plurality of gear ratios, generating the control signal based on the selected gear shifting preference.

18. The device of any one of claims 15 to 17, the electronic device further configured for:
i. receiving from a server an indication that the bicycle has been reported as being stolen;
ii. processing said received signal to generate a control signal for causing the gear ratio of the bicycle to be adjusted to a lowest gear;
iii. transmitting the control signal to the actuator.
